(19) United States
(12) Patent Application Publication
(10) Pub. No.: US 2026/0257345 A1
(43) Pub. Date: Sep. 3, 2026

(54) CANTILEVERED POSITIONING SYSTEM

(71) Applicant: Ilan Ellison Moyer, CHAPEL HILL, NC (US)

(72) Inventor: Ilan Ellison Moyer, CHAPEL HILL, NC (US)

(21) Appl. No.: 19/552,407

(22) Filed: Feb. 27, 2026

Related U.S. Application Data
(60) Provisional application No. 63/764,583, filed on Feb. 28, 2025.
(60) Provisional application No. 63/765,460, filed on Feb. 28, 2025.

(51) Int. Cl. B25J 9/10; B29C 64/209; B29C 64/236; B33Y 30/00

(52) U.S. Cl. CPC B25J 9/106; B29C 64/209; B29C 64/236; B33Y 30/00

(57) ABSTRACT

A positioning system for positioning a tool includes first and second arms coupled to respective first and second carriages movable along respective first and second guide paths. The carriages cause the arms to move the tool in a plane corresponding to a work area. The motion of the arms induces travel of the tool beyond first and second boundaries defined by a minimum inter-guide width between the guide paths, so that the work area laterally extends beyond the minimum inter-guide width.

### CROSS-REFERENCE TO RELATED APPLICATIONS

This application claims the benefit of priority to U.S. Provisional Application Nos. 63/764,583 and 63/765,460, both filed on Feb. 28, 2025, both of which are incorporated by reference herein in their entirety.

### BACKGROUND AND SUMMARY OF THE DISCLOSURE

Positioning systems (PSs) provide a means of precisely positioning a toolhead relative to a workpiece within a given work envelope, and are used in a wide variety of industrial, research, and consumer applications including metalworking equipment (e.g. CNC milling machines and lathes), PCB manufacture and assembly (e.g. mask exposure equipment, component pick-and-place, and flying-probe testers), laboratory automation (e.g. liquid handling robots), 3D printing, and many more. One key attribute of PSs is spatial efficiency, which can be defined as the ratio of the system's work envelope to the overall footprint of the non-moving portion of the PS, measured along each of three orthogonal directions (e.g. width, length, and height). Many devices utilizing PSs have a spatial efficiency less than unity in both width and length, meaning that the working area of the device is smaller than the enclosing footprint of the stationary mechanism in both footprint dimensions. For example, many 3D printers utilize PS architectures such as stacked linear axes (e.g. Prusa i3), or parallel kinematic mechanisms such as crossed bars (e.g. Ultimaker), H-Bot (e.g. Stratasys Mojo), CoreXY (e.g. Bambu Labs X1), or delta positioners (e.g. Wasp 2040).

Stacked linear axes may be preferred for simplicity and stiffness, while parallel kinematic mechanisms may be preferred for low moving mass and therefore improved dynamic performance. In all of these examples, the working area of the mechanism is smaller than its overall footprint. This is because the mechanism introduces spatial overhead outside the working envelope, such as the dimensions of actuators, travel clearance for bearings and structure, and dimensions of other structural and mechanical components. Typical consumer-grade 3D printers have linear spatial efficiencies in the range of 30-75%; spatial efficiency tends to increase with the size of the working area, because spatial overhead may be approximately fixed within a range of working area dimensions.

Spatial efficiency is an important attribute that can dictate the form-factor of equipment containing PSs, and how densely this equipment can fit on a shop floor, workbench, or shelving units. In certain applications, it may be advantageous for the PS to be able to reach outside the footprint of the static portion of the mechanism. For example, material handling devices may need to pass elements between PSs. Additionally, multiple PSs may be utilized to act on the same workpiece, for example to perform a task more quickly via parallelization, to reach larger or different areas or faces of the workpiece, or to perform differing tasks by equipping each PS with a different type of toolhead.

PS architectures have been developed to meet this need: for example, the SCARA robot arm in both series and parallel configurations have work envelopes that can be significantly larger than the fixed portion of the mechanism. However, these mechanisms, which are based on linkages driven by rotational motion, have several disadvantages. The parallel SCARA mechanism exhibits significant non-linearities which may practically limit its working envelope. Additionally, during operation the linkage arms and intermediate joints can extend far outside of the working envelope, which can require a significant amount of clearance between adjacent PSs and/or constraints on their path planning in order to avoid collisions. Serial SCARA mechanisms can similarly require clearance for the motion of their linkage arms, exhibit high inertias that limit dynamic performance, and may necessitate expensive gearboxes (e.g. Harmonic Drive transmissions) and high-resolution encoders to achieve stiffness and accuracy at the toolhead.

Embodiments of the disclosure introduce a positioning mechanism that enables high spatial efficiencies that can exceed unity along one footprint dimension, even when the work envelope is relatively small. For example, in one embodiment, a width-wise spatial efficiency of approximately 93% was achieved in a 3D printer whose working envelope has a width of 120 mm. This compares favorably with similar commercially available 3D printers such as the Voron V0.2, which has a width-wise spatial efficiency of less than 50%. Within the domain of 3D printing, the high width-wise spatial efficiency enabled by embodiments of the disclosure may allow a much higher density of 3D printers to fit into a given shelf space, thus allowing for higher productivity in a fixed floorspace in applications such as print farms, or to allow 3D printers to be situated in places where they may otherwise not comfortably fit, unlocking new use cases.

In other embodiments, multiple PSs thus constructed may be configured in various ways to enable parallel processing of a workpiece, either using similar or differing end-effectors. Examples include simultaneous 3D printing of sections of a larger piece, or milling or engraving on multiple faces of a workpiece simultaneously. PSs constructed in accordance with embodiments of the disclosure may also be arranged to pass material between adjacently positioned devices, or to access secondary materials at the periphery of the work envelope that can be brought into the primary work area; examples of this include pick-and-place or liquid handling applications. These attributes are in part enabled by the moving part of the positioning mechanism and end effector being cantilevered in front of the fixed portion of the mechanism, which allows it to reach a working envelope that is in front of the fixed mechanism as well as outside its lateral bounds.

In some embodiments, this positioning mechanism may be implemented as a purely 2D planar positioning system, or may be used as part of a 3D PS where the third orthogonal axis is implemented to lift either the workpiece or the 2D PS. Additional axes of motion including rotation may also be implemented. For example, a pick-and-place machine constructed using embodiments of the disclosure may include a toolhead with a suction head that is able to rotationally orient an electronic component such as an integrated circuit.

Embodiments of the disclosure provide a parallel kinematic mechanism that exhibits low moving mass, making it suitable for high-speed operation. While the relationship between actuator and toolhead motion of this mechanism is non-linear, it avoids the extreme singularities present in the parallel SCARA configuration. Additionally, embodiments of the disclosure utilizes linkage arms whose motion may not require additional clearance beyond the travel of the toolhead itself.

Embodiments of the disclosure provide One or more positioning systems for positioning one or more respective tools. For each system of the one or more positioning systems, the system comprises: a first arm having a first proximal end supporting the tool, and a first distal end; a second arm having a second proximal end coupled to the first arm by a third pivot, and a second distal end; a first carriage coupled to the first distal end, wherein the firs carriage is movable along a first guide path of a first guide; and a second carriage coupled to the second distal end, wherein the second carriage is movable along a second guide path of a second guide, wherein the first and second guides are offset relative to each other.

The first or second carriage, whether moving alone or in combination with the other carriage along the respective first and second guide paths, may cause motion of the tool in a plane corresponding to a work area, the first and second guides are separated by a minimum inter-guide width, wherein the minimum inter-guide width is defined by a minimum distance between lateral inner edges of the first and second guides, the first and second distal ends are rotatably coupled by first and second pivots to the first and second carriages, respectively, first and second link lengths are based upon respective distances between the third pivot and the first and second pivots, a position of the tool is based upon (a) a difference in positions between the first and second pivots, (b) the first and second link lengths, and (c) a position of at least one of the first and second pivots, and the motion of the first and second distal ends is operable to induce travel of the tool beyond first and second boundaries defined by the minimum inter-guide width, so that the work area laterally extends beyond the minimum inter-guide width.

The first and second arms may be offset from the first and second guides to avoid collision of the first and second arms with the first and second guides.

The first and second distal ends of the first and second arms may travel along the first and second guide paths, respectively, at their furthest extent to respective first and second proximal points, and to respective first and second distal points, and the work area may be defined by the area traversed by motion of the tool due to (a) motion of the first distal end over all points between the first proximal point and the first distal point, and (b) motion of the second distal end over all points between the second proximal point and the second distal point.

The work area may comprise a primary work area and one or more secondary work areas, wherein the area of the primary work area is greater than the area of any one of the secondary work areas. The primary and secondary work areas may include rectangular areas.

The system may further comprise first and second actuators for respectively driving the first and second carriages along the first and second guides in the same direction at the same time or in opposite directions.

The first and second arms may have different lengths. According to embodiments of the disclosure, each of the first and second arms may not comprise a movable joint between its proximal and distal ends (not inclusive of the ends themselves).

The first and second guide paths may be linear guide paths. The first and second arms may be curved to avoid collision of the first and second arms with the first and second guides.

Other embodiments may provide first and second positioning systems for positioning one or more respective tools. For each of the one or more positioning systems, the system may comprise: a first arm having a first proximal end supporting the tool, and a first distal end; a second arm having a second proximal end coupled to the first arm by a third pivot, and a second distal end; a first carriage coupled to the first distal end, wherein the first carriage is movable along a first guide path of a first guide; and a second carriage coupled to the second distal end, wherein the second carriage is movable along a second guide path of a second guide, wherein the first and second guides are offset relative to each other. The first or second carriage, whether moving alone or in combination with the other carriage along the respective first and second guide paths, may cause motion of the tool in a plane corresponding to a work area, the first and second guides are separated by a minimum inter-guide width, wherein the minimum inter-guide width is defined by a minimum distance between lateral inner edges of the first and second guides, the first and second distal ends are rotatably coupled by first and second pivots to the first and second carriages, respectively, first and second link lengths are based upon respective distances between the third pivot and the first and second pivots, a position of the tool is based upon (a) a difference in positions between the first and second pivots, (b) the first and second link lengths, and (c) a position of at least one of the first and second pivots. The first arm of the first positioning system, when supporting a first tool, and the first arm of the second positioning system, when supporting a second tool, may enable work by the first and second tools within a common work area comprising an overlap of the work areas of the first and second tools.

The first and second positioning systems may enable work by the first and second tools on the same workpiece.

### BRIEF DESCRIPTION OF THE DRAWINGS

FIG. 1 shows a top-down view of a 2D positioning system constructed in accordance with embodiments of the disclosure.

FIG. 2A illustrates in more detail the embodiment of FIG. 1 and its kinematics.

FIG. 2B illustrates carriage positions for the embodiment of FIG. 2A.

FIG. 2C shows the embodiment of FIG. 2A, with additional detail on the working area.

FIG. 2D illustrates a configuration in which relief clearance is provided for the toolhead in specific areas behind a clearance plane, according to embodiments of the disclosure.

FIG. 3A is a partially schematized drawing of the embodiment of FIG. 2C, that describes the geometric relationships between various components according to embodiments of the disclosure.

FIG. 3B provides mathematical equations that relate the proximal pivot position relative to a reference pivot to the lengths of first and second links, an inter-guide path distance, and distal pivot differential distance.

FIG. 3C is a partially schematized drawing of the embodiment of FIG. 2C that illustrates the position of a proximal pivot within a sub work-area based on various components of the system shown in FIGS. 3A and 3B.

FIG. 3D illustrates how the lengths of the first and second arms and other design parameters may be determined in accordance with embodiments of the disclosure.

FIGS. 3E and 3F illustrate how changing the distal pivot bearing distances and arm lengths may affect the maximum working area shape as well as estimated dynamic performance and other attributes.

FIG. 3G illustrates a system constructed in accordance with embodiments of the disclosure.

FIG. 3H shows a first system and a second system constructed in accordance with the embodiment of FIG. 3G, that may be placed adjacently with a minimal inter-system running distance.

FIG. 3I shows a system constructed in accordance with embodiments of the disclosure, in which a toolhead may be coupled to a first arm at its proximal end.

FIGS. 4A and 4B show different views of a system constructed in accordance with embodiments of the disclosure that is similar to the system of FIG. 1.

FIGS. 5A-5B illustrate a system constructed in accordance with the disclosed embodiments, in which the planar positioning system of FIG. 4A is located relative to a working surface such that a sub-working area may be within the bounds of a working surface.

FIG. 5C shows a 3D isometric view of the system of FIG. 5A.

FIG. 6 is an isometric view of a bookshelf 3D printer designed in accordance with the embodiments described.

FIG. 7A shows another embodiment of the disclosure, in which a primary sub-work area is defined within a maximal working area (MWA), and at least one other secondary sub-working area (SSWA) may also be defined within the MWA (e.g. a first SSWA and a second SWWA).

FIG. 7B illustrates an arrangement of two adjacently located systems constructed in accordance with the disclosed embodiments, in which there is partial or full overlap of secondary sub-working areas between the machines.

FIG. 8 shows another embodiment of the disclosure in which a toolhead is positioned relative to a working surface by a planar positioning system constructed in accordance with embodiments of the disclosure.

FIG. 9 shows how two positioning systems constructed in accordance with embodiments of the disclosure may be adjacently positioned and perform work on a common working area.

FIG. 10 shows how multiple positioning systems may be arrayed adjacently to achieve high lateral packing densities.

FIG. 11 shows three positioning systems arranged in order to access a common working area.

FIG. 12 shows an embodiment of the disclosure in which a 2D planar positioning system constructed in accordance with embodiments of the disclosure may be actuated to move in a third direction that may be perpendicular to its work area.

FIG. 13 illustrates an arrangement of systems constructed in accordance with the embodiments of the disclosure in which multiple positioning systems (e.g. 1300, 1302, 1304, 1306) are able to each independently position their respective toolheads within a working volume.

FIGS. 14A-14C shows an embodiment of the disclosure in which a first arm has a first distal end coupled to a first carriage by a first pivot, and a second arm has a second distal end coupled to a second carriage by a second pivot.

### DETAILED DESCRIPTION

According to embodiments of the disclosure one or more positioning systems for positioning one or more respective tools, wherein, for each of the one or more positioning systems, the system comprises:
a first arm having a first proximal end supporting the tool, and a first distal end;
a second arm having a second proximal end coupled (e.g., directly or indirectly) to the first arm by a third pivot (e.g., a “proximal pivot”), and, and a second distal end;
   a first carriage coupled to the first distal end, wherein the first carriage is movable along a first guide path of a first guide; and
   a second carriage coupled to the second distal end, wherein the second carriage is movable along a second guide path of a second guide, wherein the first and second guides are offset relative to each other,
wherein:
   the first or second carriage, whether moving alone or in combination with the other carriage along the respective first and second guide paths, causes motion of the tool in a plane corresponding to a work area,
   the first and second guides are separated by a minimum inter-guide width, wherein the minimum inter-guide width is defined by a minimum distance between lateral inner edges of the first and second guides,
   the first and second distal ends are rotatably coupled by first and second pivots to the first and second carriages, respectively,
   first and second link lengths are based upon respective distances between the third pivot and the first and second pivots,
   a position of the tool is based upon (a) a difference in positions between the first and second pivots, (b) the first and second link lengths, and (c) a position of at least one of the first and second pivots, and
   the motion of the first and second distal ends is operable to induce travel of the tool beyond first and second boundaries defined by the minimum inter-guide width, so that the work area laterally extends beyond the minimum inter-guide width.

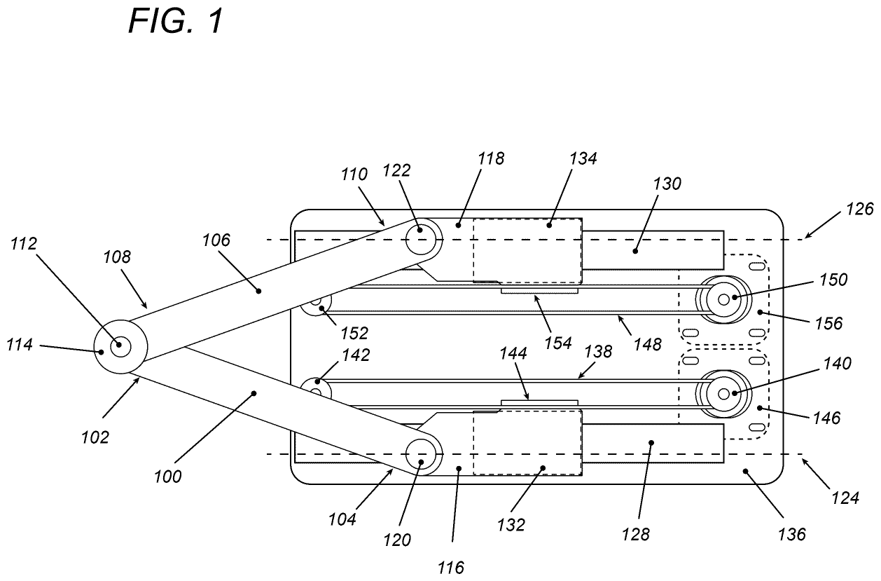

FIG. 1 shows a top-down view of a 2D positioning system constructed in accordance with embodiments of the disclosure. A first arm 100, with a first proximal end 102 and a first distal end 104, is connected to a second arm 106, having a second proximal end 108 and a second distal end 110, at a proximal pivot point 112 located at the proximal end of both arms. In this embodiment, located coaxially with this pivot point is a mount 114, which may be rigidly attached to the second arm 106.

In alternative embodiments, the pivot point connecting both arms may be not co-located with the mount, and both the mount and the pivot may be placed in other positions relative to each arm. According to embodiments of the disclosure, the first and second arm are connected to a first carriage 116 and second carriage 118 respectively, via a first distal pivot 120 and a second distal pivot 122 respectively, each located at the distal ends of their respective arms.

Pivots 112, 120, and 122 are shown with their axes of rotation perpendicular to the plane of the drawing. These pivots may be understood to allow the first and second arms to rotate freely relative to their respective first and second carriages (within a limited or unlimited range of motion), while rigidly coupling the two members in one or more additional degrees of freedom.

For example, distal pivots 120 and 122 may allow the first and second arms to rotate freely with respect to the carriages 116 and 118, but transfer pitch moment or shear loads (e.g. as a result of a force applied to the mount) into the carriages with minimal deflection at the pivot joint. These pivots may be constructed using radial bearings (e.g. plain bushings, deep-groove conrad ball bearings, etc.), thrust bearings, angular contact bearings, or other types of bearings, in any combination suitable to transfer load between both members with suitable rigidity, while permitting free rotation about the pivot point. In a preferred embodiment, these bearing components may be preloaded to eliminate free play and to maximize stiffness within the expected operating loads that they may experience.

The first and second carriages are constrained to move along a first guide path 124 and a second guide path 126, respectively, by a first guide 128 and a second guide 130, respectively. These guide paths are shown in FIG. 1 passing through the rotational axes of the first and second distal pivots. A first bearing 132 and a second bearing 134 (shown in FIG. 1 as beneath the carriages) may be rigidly coupled to the first and second carriages, respectively, and interface with the first and second guides respectively so as to precisely constrain the motion of the carriages along a guide path while rigidly transferring some or all loads not along these guide paths (e.g. moments and forces) between the bearings and guides with minimal deflection.

The first and second bearings and guides shown in FIG. 1 are of the linear profile rail type with recirculating-ball bearing blocks. However, any type of guide (e.g., circular shafts with plain or ball bushings, box ways, roller guides, etc.) may be used. According to embodiments of the disclosure, the first and second bearings may be preloaded with respect to the guides, so as to eliminate free play and maximize stiffness. In a preferred embodiment, as shown in FIG. 1, the first and second guides are straight and run parallel to each other; using straight guides takes advantage of standard commercially-available off-the-shelf linear motion guide systems.

However, in alternative embodiments, the first or second guides may be curved, or may run not parallel to each other. The first and second guides may be rigidly mounted to a structure such as the baseplate 136 shown in FIG. 1, and are fixed with screws at regular points along their length, as is customary with profile guiderails as shown. In alternative embodiments, the guides may be fixed along their lengths, or fixed just at their ends (as is common with round shaft bearing systems), and may be supported by any mechanical structure suitable to the purpose of the machine in which the positioning system is built and in accordance with embodiments of the disclosure.

In the embodiment of FIG. 1, a first belt 138 is looped around a first drive pulley 140 and a first idler pulley 142, and is fixed to the first carriage by a first belt clamp 144. A first motor 146 is coupled to the first drive pulley such that a rotation of the first motor results in an equal rotation of the first drive pulley, which in turn results in a linear motion of the first belt at the point it is clamped to the first carriage, which may in turn result in a corresponding motion of the first carriage along the guide. Similarly, a second belt 148 is looped around a second drive pulley 150 and a second idler pulley 152, and is fixed to the second carriage by a second belt clamp 154. A second motor 156 is coupled to the second drive pulley such that a rotation of the second motor results in an equal rotation of the second drive pulley, which in turn results in a linear motion of the second belt at the point it is clamped to the second carriage, which may in turn result in a corresponding motion of the second carriage along the guide.

The relationship between the angular rotation of the motors and the motion of their corresponding carriages may be determined by the pitch diameter of the corresponding drive pulley. In the embodiment shown, a stepper motor with 1.8 degrees per step is used, and the belt may be tensioned by sliding the motor in slots within the baseplate. It will be clear to somebody skilled in the art that alternative embodiments within the scope of this disclosure may use a variety of actuators and transmissions in order to position the carriage along the guide. These may include but are not limited to: rack and pinion, capstans and cables, leadscrews, brushed and brushless AC and DC motors, stepper motors, linear motors (including linear stepper motors), etc. Such actuators and transmissions may be chosen based on required positioning resolution, repeatability, and accuracy, or required stiffness, or dynamic performance, among other considerations. For example, a leadscrew drive with a fine pitch may provide higher positioning accuracy and higher stiffness than a belt drive, but may require significantly more powerful actuators to achieve similar dynamic performance.

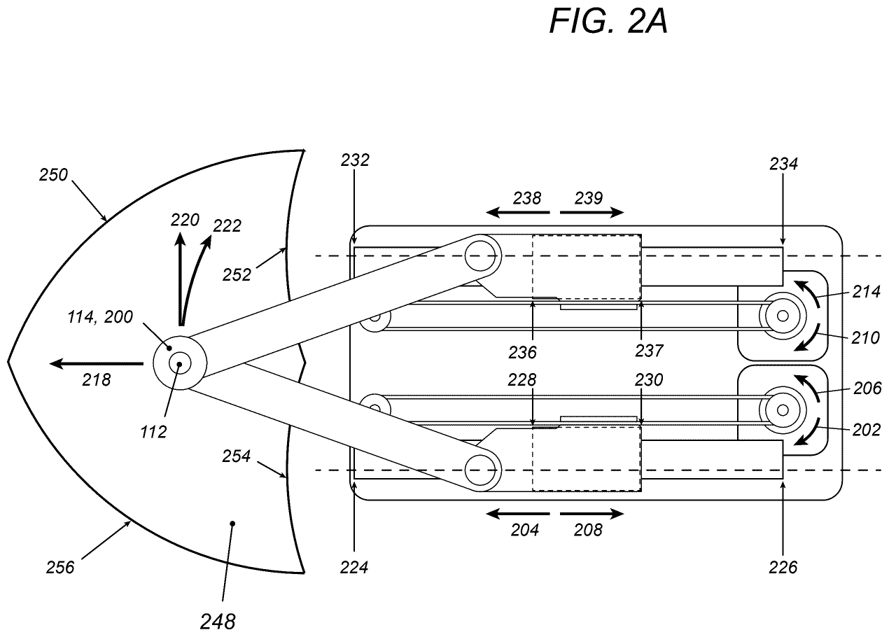

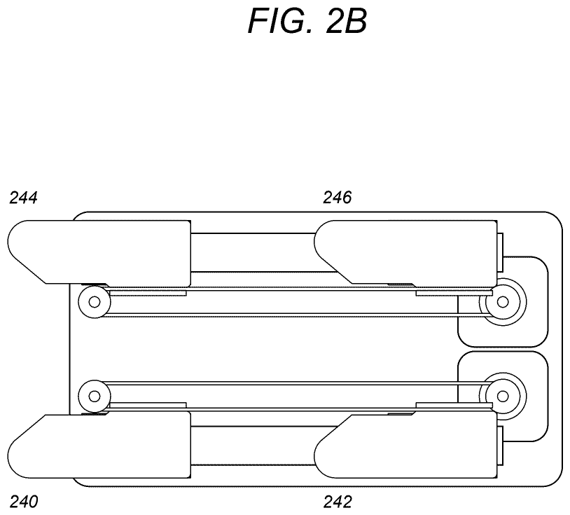

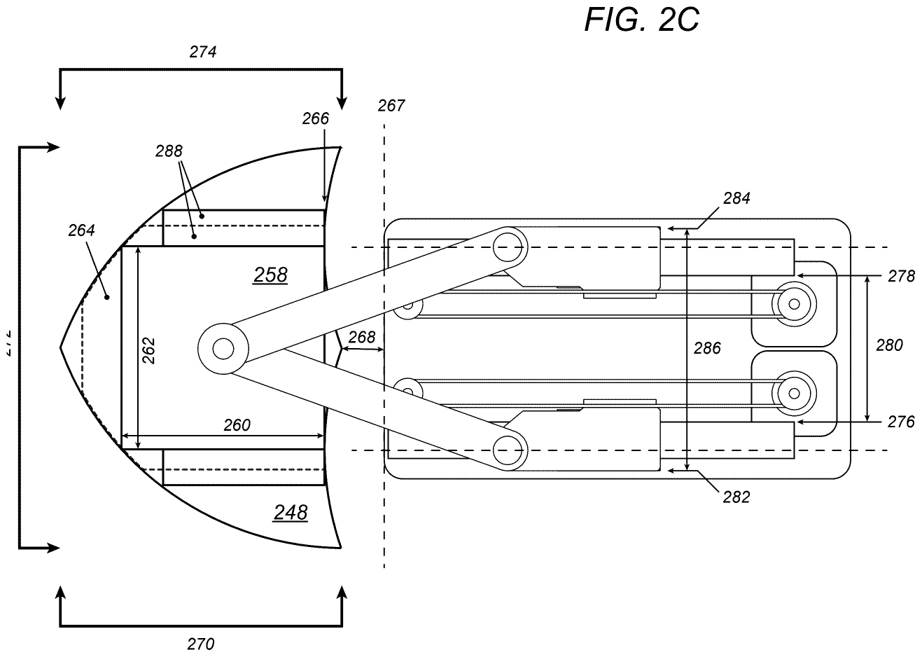

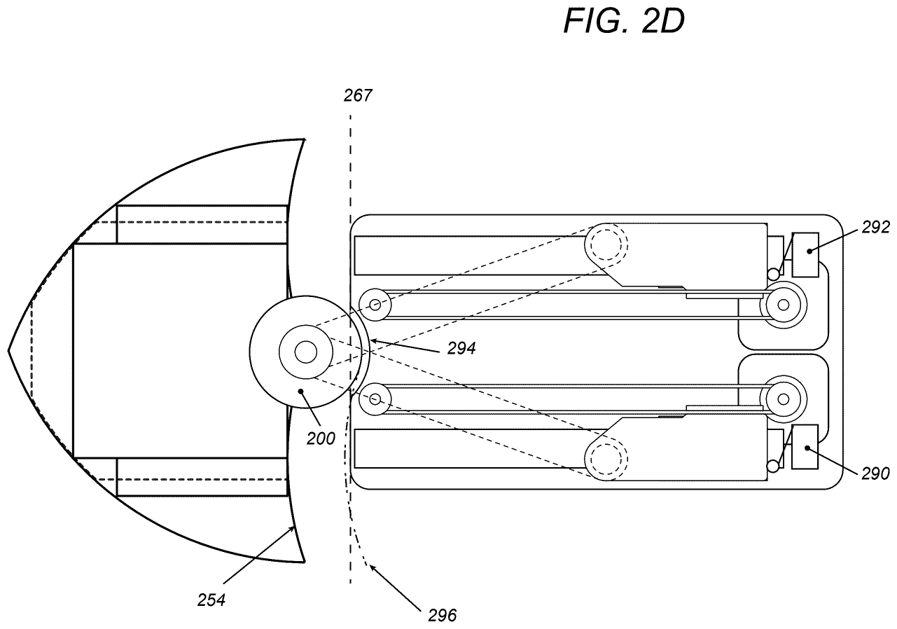

FIG. 2A describes in more detail the embodiment of FIG. 1 and its kinematics. According to embodiments of the disclosure, a toolhead 200 is rigidly fixed to the mount 114, coaxial with both the mount and the proximal pivot 112. Toolheads are end effectors which may perform work, manipulation, or sensing on a workpiece; examples include machining spindles, cutting knives, 3D printing extruders, lasers, pipetters, electrical probes, sensors, etc. Some of these may have an obvious axis, such as the extrusion direction of a 3D printing toolhead, or the axis of rotation of a machining spindle.

For the purposes of the following description, we will refer to this axis as the toolhead axis, which in the embodiment of FIG. 1 is coaxial with the mount and proximal pivot. In general, we may consider the toolhead axis to be the axis perpendicular to the plane of motion of the positioning system that passes through a central point at which the toolhead performs work, or a point representative of the location of this work (e. g the center point of a camera's field of view).

In the embodiment of FIG. 2A, the first motor may rotate in a first clockwise direction 202, which may cause the first carriage to move in a first proximal direction 204. The first motor may alternatively move in a first counterclockwise direction 206, which may cause the first carriage to move in a first distal direction 208. The second motor may rotate in a second clockwise direction 210, which may cause the second carriage to move in a second distal direction 239. The second motor may alternatively move in a second counterclockwise direction 214, which may cause the second carriage to move in a second proximal direction 238.

When both carriages move at the same rate in their respective proximal directions, the toolhead axis moves in a third proximal direction 218 that may be parallel to the first and second guide paths, and perpendicular to a third orthogonal direction 220. When the first carriage moves in the first proximal direction, and the second carriage moves in the second distal direction, the toolhead axis moves along a third arcuate path 222 that is primarily aligned with the third orthogonal direction 220. The first and second carriages may each be moved in the same or opposite directions at independent rates, or may remain stationary. In this way, the positioning system of FIG. 2A may be located within a 2D plane.

In the embodiment of FIG. 2A, the first guide 128 may have a first guide proximal edge 224 and a first guide distal edge 226, and the first bearing 132 may have a first bearing proximal edge 228 and a first bearing distal edge 230. Similarly, the second guide 130 may have a second guide proximal edge 232 and a second guide distal edge 234, and the second bearing 132 may have a second bearing proximal edge 236 and a second bearing distal edge 237.

FIG. 2B illustrates these carriage positions for the embodiment of FIG. 2A, with corresponding legends. When the first bearing proximal edge is at its closest position to the first guide proximal edge, we consider the first carriage to be in a first proximal carriage position 240. When the first bearing distal edge is at its closest position to the first guide distal edge, we consider the first carriage to be in the first distal carriage position 242. When the second bearing proximal edge is at its closest position to the second guide proximal edge, we consider the second carriage to be in a second carriage proximal position 244. When the second bearing distal edge is at its closest position to the second guide distal edge, we consider the second carriage to be in the second carriage distal position 246. As used in this disclosure, the term “carriage” may be construed to mean a carriage assembly that includes the bearing that interfaces a carriage to its respective guide.

In the embodiment of FIG. 2A, these carriage positions may be set to allow a nominal amount of unused travel on the proximal and distal ends of the profile rail guides. However, in other embodiments, additional considerations may determine how close the bearing edges get to the guide edges. For example, mechanical interferences between moving and stationary elements of the mechanism or surrounding structure may influence the actual proximal and distal carriage positions. In the embodiment of FIG. 2A, the proximal edges of both guides may be collinear, as may be the distal edges of both guides, resulting in both guides having the same length. However, in alternative embodiments, the guides may have different lengths.

In the embodiment of FIG. 2A, a maximal working area (MWA) 248 may be defined as the boundary of the space accessible by the toolhead axis with the carriages movable between their respective proximal and distal positions. This boundary may be defined by four segments. A first MWA segment 250 may be the arc swept by the toolhead axis when the first carriage remains in the first carriage proximal position, and the second carriage is moved from the second carriage proximal position to the second carriage distal position.

A second MWA segment 252 may be the arc swept by the toolhead axis when the second carriage remains in the second carriage distal position, and the first carriage is moved from the first carriage proximal position to the first carriage distal position.

A third MWA segment 254 may be the arc swept by the toolhead axis when the first carriage remains in the first carriage distal position, and the second carriage is moved from the second carriage distal position to the second carriage proximal position.

A fourth MWA segment 256 may be the arc swept by the toolhead axis when the second carriage remains in the second carriage proximal position, and the first carriage is moved from the first carriage distal position to the first carriage proximal position.

FIG. 2C shows the embodiment of FIG. 2A, with additional detail on the working area. One or more subsets of the maximal working area may be defined; doing so may be desirable in order to normalize the unusual shape of the working area, so that both users and process planning software (e.g., computer-aided manufacturing CAM software) are able to reason about the capabilities of a machine constructed in accordance with embodiments of the disclosure. For example, a rectangular first sub-working area (SWA) 258 may be defined with a SWA width 262 and a SWA depth 260. This SWA 258 may be fully inscribed within the MWA 248 as shown, or may be truncated in part by the MWA, such as second sub-working area 264. Such truncation may be acceptable in certain cases, such as when the workpieces are predominantly circular in footprint, while allowing the dimensions of the SWA to be maximized. In general, the dimensions of the SWA may be chosen to maximize the working area (e.g., the product of the SWA width and SWA depth), or to balance these dimensions in order to meet machine or process-specific requirements, e.g., by satisfying one dimension while maximizing the other.

The SWA may have a rear SWA edge 266, that may be tangent to the second or third MWA segment 252, 254. In some embodiments, the shape of the MWA may be such that such tangency is not possible; in these cases, the SWA may have one or more vertices that lie on the second or third MWA segments. In the embodiment shown in FIG. 2A, the positioning system has been designed such that all mechanical and structural components such as for example the guides and baseplate-that may interfere with the motion of the toolhead as it moves within the SWA, have been located behind a clearance plane 267 (shown on its edge in FIG. 2C). Furthermore, the rear SWA edge-which is tangent to the second and third MWA segments in order to maximize the depth of the SWA-is separated by a positive gap 268 from this clearance plane. The SWA is thereby accessible without obstruction from a first access direction 270, second access direction 272, and a third access direction 274. This may have several advantages over prior art: for user access when loading workpieces, for performing work on workpieces that extend outside the bounds of the SWA, and as disclosed later in this specification, for multiple positioning systems to do work within a common working area. The dimension of the positive gap may be chosen to allow suitable clearance (e.g. 0.5 mm, 1 mm, 2 mm, 3 mm, 5 mm, 10 mm, etc) of the periphery of the toolhead relative to the clearance plane, when the toolhead axis is located on the rear SWA edge.

It should be noted that the toolhead may penetrate the clearance plane during certain operations of the mechanism, including a homing routine. During such a routine, the carriages may traverse to a specific position (e.g., their carriage distal positions) in order to make contact with a detector such as a limit or proximity switch. These detectors may be used in conjunction with rotational or linear encoders that may have an indexing feature. For example, it is common practice in the art for a linear positioning system that is driven by a rotational actuator to use a limit switch to locate the actuator within a given revolution, and then an index track on a rotational encoder (e.g., transmissive or reflective optical encoder) to very precisely determine position within that revolution.

When used in this way, the precise position of the carriages relative to the structure of the positioning system may be determined. The mechanics and structure of embodiments of the disclosure may be configured such that relief clearance is provided for the toolhead in specific areas behind the clearance plane. This configuration is illustrated in FIG. 2D, where the first and second carriages are at their first and second carriage distal positions against a first limit switch 290 and a second limit switch 292 respectively, and the toolhead is shown enlarged so as to penetrate the clearance plane.

These limit switches are illustrative, and may take other locations and forms depending on the needs of the specific embodiment. The arms are drawn with transparency, so that baseplate cutout 294 is visible. This cutout or other relieving features may provide clearance for the toolhead behind the clearance plane 267 during operation of the positioning mechanism. The shape of the baseplate cutout may be designed so that the toolhead will remain in clearance with the mechanism and structure of the positioning system at any point in the MWA; for example, when following the third MWA segment 254.

As an illustrative example, a toolhead perimeter path 296 illustrates the trajectory of the toolhead perimeter (as drawn) as it follows the third MWA segment 254. The baseplate cutout may be shaped so as to provide clearance on this trajectory. This may be useful for a homing routine, because until the routine is performed, the positions of each carriage are unknown to a control system; it is therefore possible that the homing routine begins anywhere within the MWA, and relieving the mechanism and structure of the positioning system behind the clearance plane to accommodate this motion can prevent collisions during homing. In some embodiments, the clearance plane may be conceptualized as a clearance surface that is not planar.

FIG. 2C additionally shows the first guide inner edge 276 and second guide inner edge 278. We define the distance between these inner edges as the minimum inter-guide distance (MIGD) 280. In a positioning mechanism constructed in accordance with embodiments of the disclosure, a useful SWA has a width (e.g., 262) greater than the MIGD. This has a significant advantage over prior art, in that the spatial efficiency of the positioning mechanism can approach or exceed unity.

For clarity, we may define the spatial efficiency of the embodiment of FIG. 2C by first defining a first carriage outer edge 282, a second carriage outer edge 284, and the distance between these edges as the maximal outer-carriage distance (MOCD) 286. This is a relevant dimension because the MOCD (plus a small amount of clearance) may be the closest pitch at which two positioning systems may be placed adjacently without interfering, or the minimal distance that might separate generic objects placed on either side of the positioning system. The spatial efficiency would therefore be the ratio of the SWA width relative to the MOCD. A third SWA 288 demonstrates a spatial efficiency greater than 1.

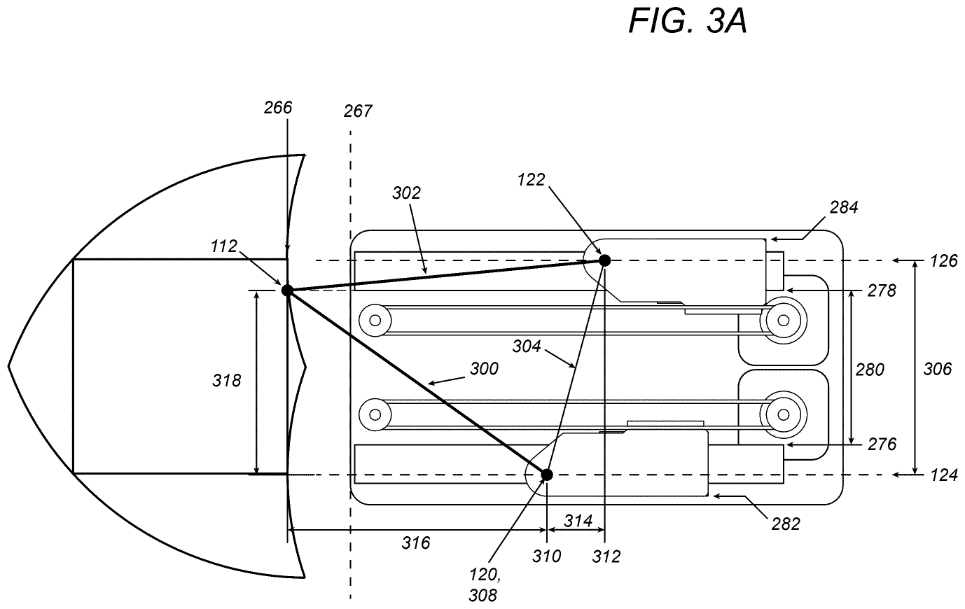

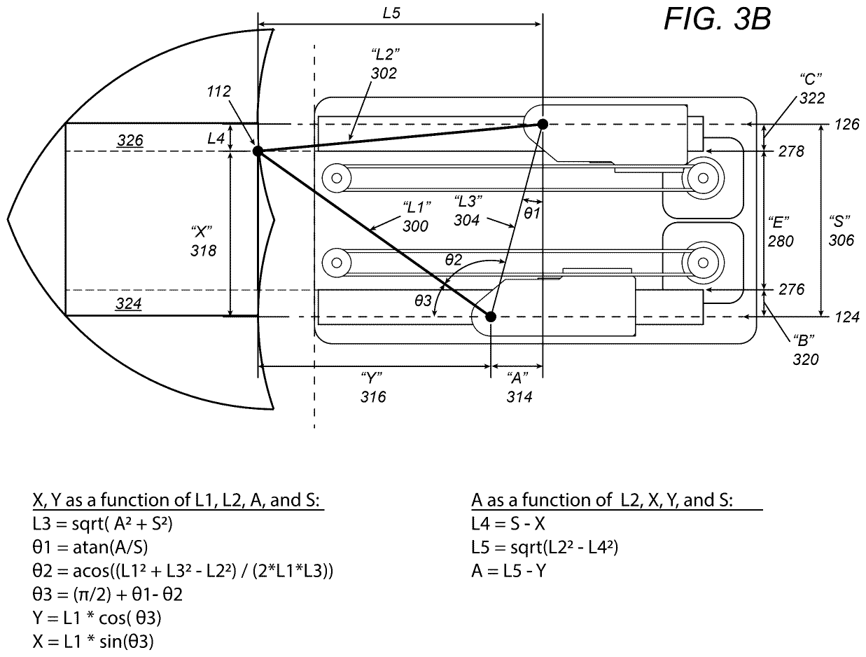

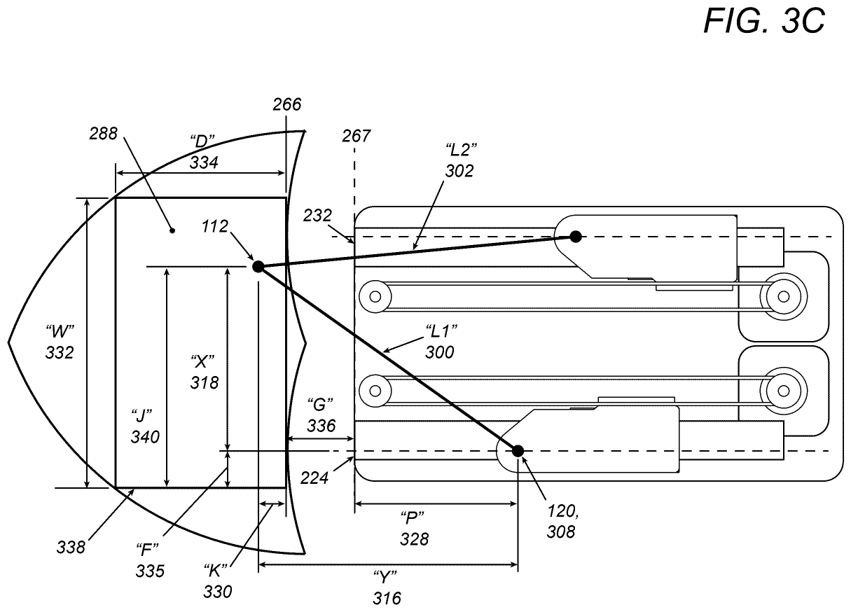

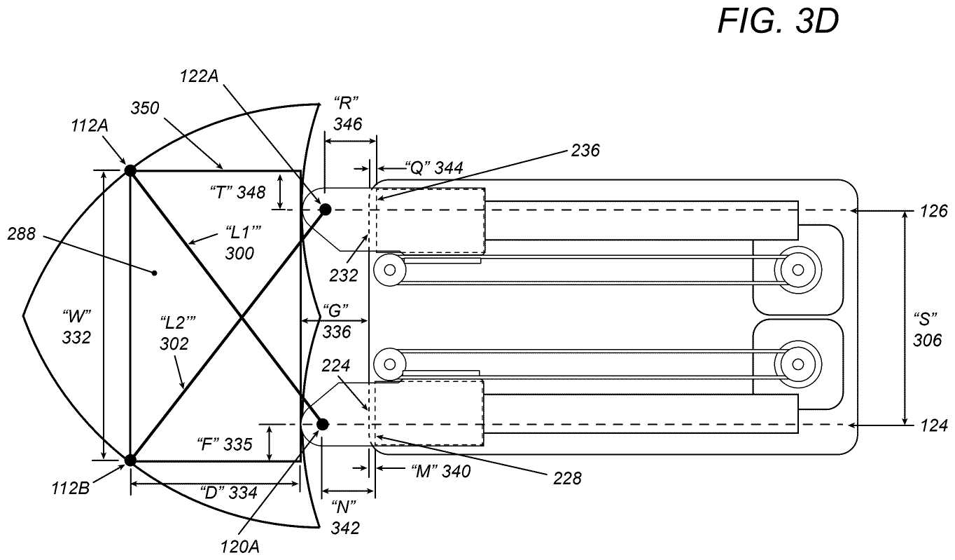

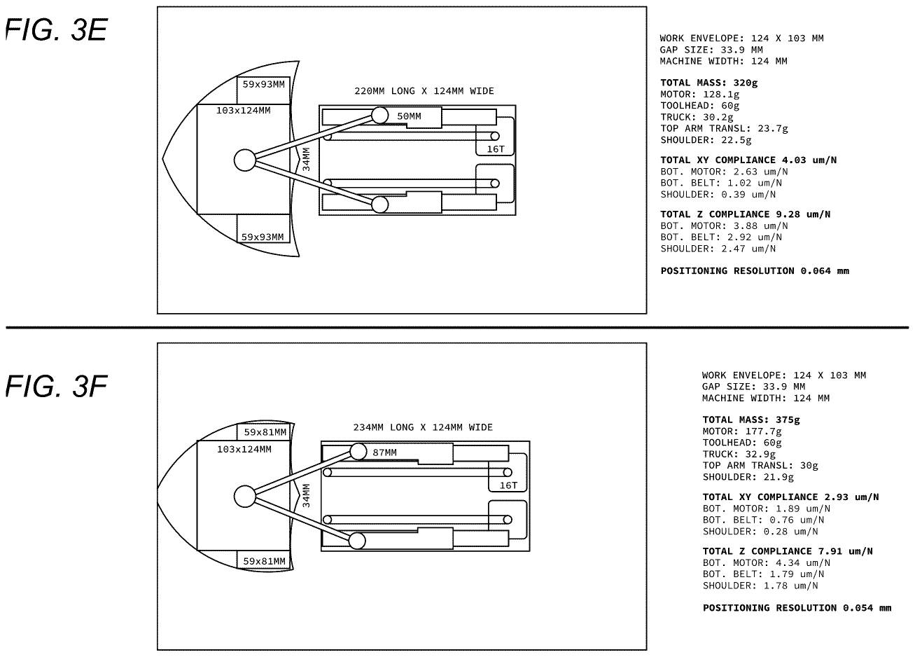

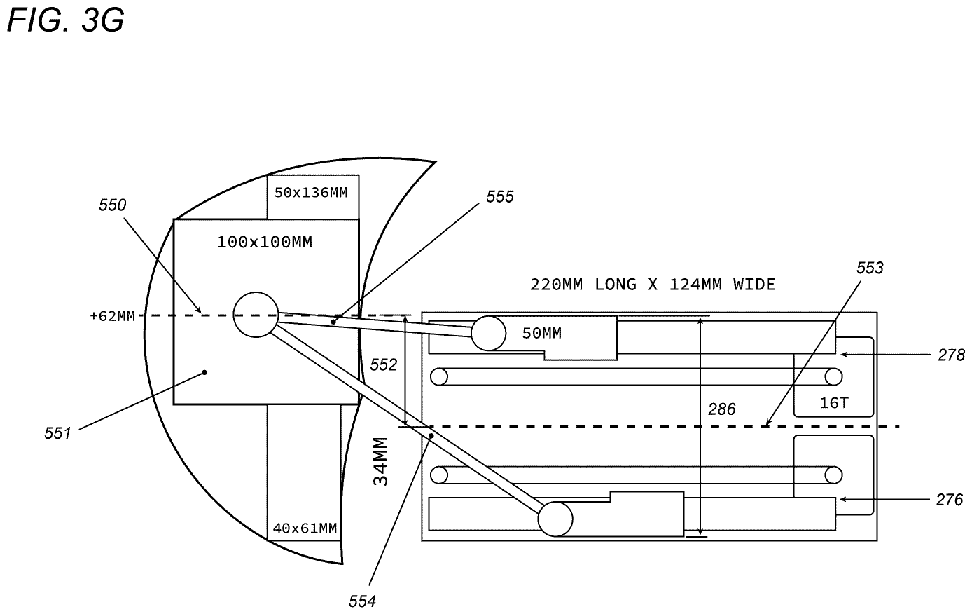

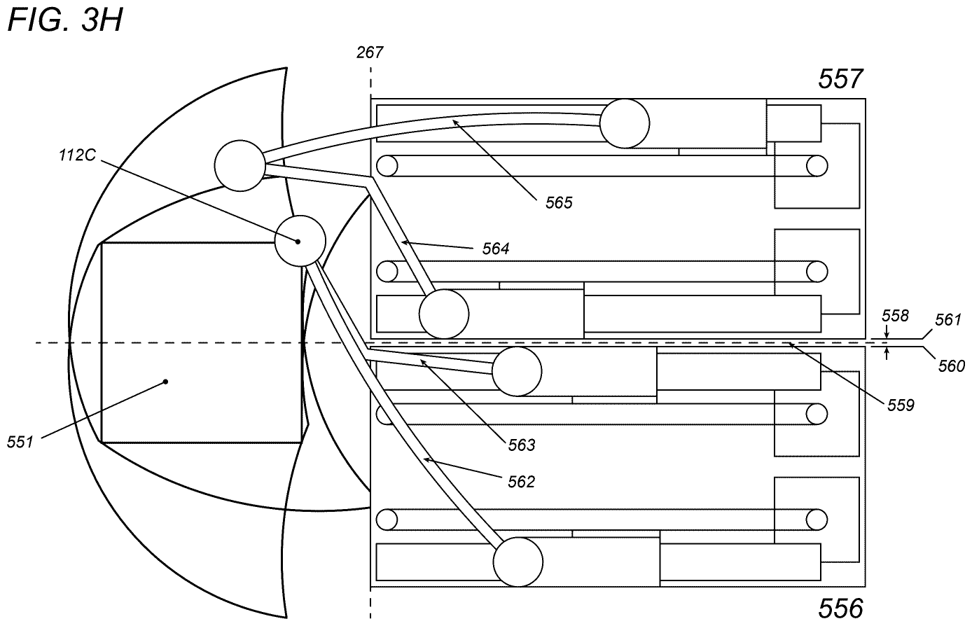

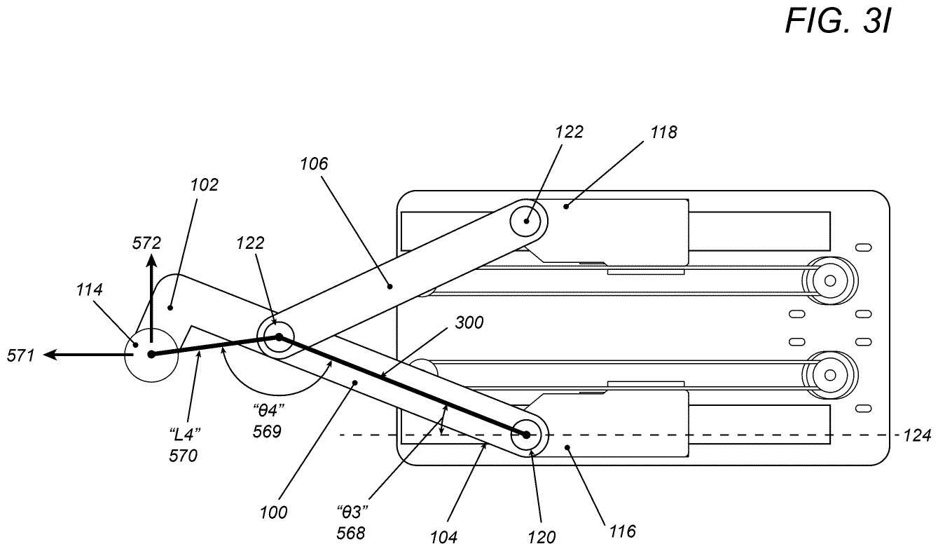

FIG. 3A is a partially schematized drawing of the embodiment of FIG. 2C, that describes the geometric relationships between various components according to embodiments of the disclosure. A first link 300 is a line segment that connects the axis of first distal pivot 120 to the axis of proximal pivot 112, and may be representational of a portion of the first arm 100. A second link 302 is a line segment that connects the axis of second distal pivot 122 to the axis of proximal pivot 112, and may be representational of a portion of the second arm 106. As in FIG. 2A, Mount 114 and Toolhead 200 are coaxial with the proximal pivot in the present embodiment.

A distal pivot segment 304 is a virtual line segment connecting the axis of the first distal pivot to the axis of the second distal pivot. Note that this distal pivot segment may not correspond to a physical element of the mechanism, and that the length of this segment may depend on the relative positions of the first and second distal pivots during operation. As in FIG. 2, the first distal pivot moves along a first guide path 124 that is parallel to the first guide, and the second distal pivot moves along a second guide path 126 that is parallel to the second guide. We may define an inter-guide path distance (IPGD) 306, which is the distance between the two guide paths.

For the sake of clarity, in this description of FIG. 3A, we follow the embodiment of FIG. 2C, in which the first and second guides and therefore the first and second guide paths are straight and run parallel to each other. We may define a reference pivot 308, which may be the same as the distal pivot 120. We furthermore may define a reference pivot location 310 that is the location of the reference pivot along its corresponding guide path (e.g. the first guide path as in FIG. 3A), and a second distal pivot location 312 that is the location of the second distal pivot along the second guide path, We may define a distal pivot differential distance 314, which is the distance between the reference pivot location and the second distal pivot location, projected along the first guide path. The position of the proximal pivot 112, relative to the reference pivot 308, may be defined by an anterior pivot distance 316 that is the distance between the proximal and reference pivots projected onto the first guide path, and by a transverse pivot distance 318 that is the distance between the proximal and reference pivots projected onto a line perpendicular to the first guide path.

FIG. 3B provides mathematical equations that relate the proximal pivot position relative to the reference pivot (e.g., as given by the anterior 316 and transverse 318 pivot distances), to the lengths of the first 300 and the second 302 links, the IPGD 306, and the distal pivot differential distance 314. Note that for the sake of clarity, these parameters have been assigned letter variables thusly:
S—Inter Guide Path Distance 306
A—Distal Pivot Differential Distance 314
L1—First Link 300 Length
L2—Second Link 302 Length
L3—Distal Pivot Segment 304 Length
X—Transverse Pivot Distance 318
Y—Anterior Pivot Distance 316

FIG. 3B additionally defines intermediate angles θ1, θ2, and θ3, and intermediate lengths L4 and L5 (as shown) to assist in the calculations.

These equations state the anterior and transverse pivot distances as a function of the first and second link lengths, the distal pivot differential distance, and the inter guide path distance:

$$L 3 = sqrt ( {A}^{2} + {S}^{2} ) \qquad Eq 1$$

$$θ 1 = a tan ( A / S ) \qquad Eq 2$$

$$θ 2 = a cos ( ( L {1}^{2} + L {3}^{2} - L {2}^{2} ) / ( 2 * L 1 * L 3 ) ) \qquad Eq 3$$

$$θ 3 = ( π / 2 ) + θ 1 - θ 2 \qquad Eq 4$$

$$X = L 1 * cos ( θ 3 ) \qquad Eq 5$$

$$Y = L 1 * sin ( θ 3 ) \qquad Eq 6$$

The distal pivot differential distance can similarly be stated as a function of the second link length, anterior and transverse pivot distances, and the inter guide path distance:

$$L 4 = S - X \qquad Eq 7$$

$$L 5 = sqrt ( L {2}^{2} - L {4}^{2} ) \qquad Eq 8$$

$$A = L 5 - Y \qquad Eq 9$$

We may additionally define a first inner guide to guide path distance 320, which is the distance between the first guide inner edge 276 and the first guide path 124, and a second inner guide to guide path distance 322, which is the distance between the second guide inner edge 278 and a second guide path 126. For the sake of clarity, parameters have been assigned letter variables thusly:
B—First Inner Guide to Guide Path Distance 320
C—Second Inner Guide to Guide Path Distance 322
E—Minimum Inter-Guide Distance 280

In a positioning mechanism constructed in accordance with embodiments of the disclosure, and in which the toolhead may be coaxial with the proximal pivot, the toolhead axis may be enabled to operate outside the minimum inter-guide distance (MIGD) 280 by setting the distal pivot differential distance such that, for a given mechanism design that includes lengths of the first and second link and the inter-guide path distance, the transverse pivot distance may be greater than the first inner guide to guide path distance plus the MIGD, or the transverse pivot distance may be less than the first inner guide to guide path distance. This may occur when either of the following equations hold true:

$$X < B \qquad Eq 10$$

$$or$$

$$X > ( B + E ) \qquad Eq 11$$

The mechanism of the embodiment of FIG. 3B is shown positioned at the critical point where the toolhead axis (which in this embodiment may be coaxial with the mount and the proximal pivot) is on the second guide inner edge 278. In the example shown, should the distal pivot differential distance be increased, the toolhead will exit the MIGD. In a positioning mechanism constructed in accordance with embodiments of the disclosure, motion of the toolhead that is inside an SWA but outside the MIGD (e.g., regions 324 and 326 as shown) may be accessible by the toolhead axis while the first and second carriages remain inside the zone between their respective proximal and distal positions, or with the mechanism components (e.g., the first or second arms, or the first or second carriages, or the mount, or the toolhead, or the guides, or the structure, etc.) moving freely without mechanical interference.

FIG. 3C is a partially schematized drawing of the embodiment of FIG. 2C, that illustrates the position of the proximal pivot 112 within a sub work-area based on various components of the system shown in FIGS. 3A and 3B.

A sub-working area (SWA) 288 may have an SWA width 322 and an SWA depth 334. Furthermore, the SWA rear edge 266 may be located a gap distance 336 from a first guide proximal edge 226. In the embodiment of FIG. 3C, the first guide proximal edge may be coincident with the second guide proximal edge 232, which may also be coincident with the clearance plane 267, such that gap distance 336 corresponds with the positive gap 268 in FIG. 2C. The SWA bottom edge 338 may be located a first offset distance 335 from the first guide path 124, along which the reference pivot 308 (which may be the first distal pivot 120) moves. While equations 1-9 relate the position of the proximal pivot 112 to the reference pivot, the following description may relate these relative distances (e.g., the anterior pivot distance 316 and the transverse pivot distance 318) to the position of the proximal pivot within the SWA. In embodiments where the toolhead is coaxial with the proximal pivot, this description may serve to relate these relative distances 316 and 318 to the position of the toolhead within the SWA.

We may additionally define: a first distal pivot position 328 as the distance between the first guide proximal edge and the position of the reference pivot; an anterior pivot SWA distance 330, which is the distance between the proximal pivot and the SWA rear edge; and transverse pivot SWA distance 340, which is the distance between the proximal pivot and the SWA bottom edge.

For the sake of clarity, these parameters have been assigned letter variables thusly:
D—SWA Depth 334
W—SWA Width 332
G—Gap Distance 336
F—First Offset Distance 335
P—First Distal Pivot Position 328
J—Transverse Pivot SWA Distance 340
K—Anterior Pivot SWA Distance 330

The following equations relate the anterior pivot distance 316 and the transverse pivot distance 318 to the anterior pivot SWA distance 330 and the transverse pivot SWA distance 340:

$$J = X + F \qquad Eq . 12$$

$$K = Y - P - G \qquad Eq . 13$$

According to embodiments of the disclosure, the positions of the first and second distal pivots along their guide paths that correspond to positions of the proximal pivot (that in some embodiments may be coaxial with the toolhead) can be determined from Eq. 12 and 13 above, in conjunction with their referenced equations. For a specific instance of the system (e.g., the link lengths, inter guide path distance, gap distance, first offset distance being fixed), a first scenario may be that the first distal pivot position changes, while the distal pivot differential position remains constant. In this first scenario, it may be that the anterior pivot SWA distance changes while the transverse SWA distance remains constant. In a second scenario, the first distal pivot position may remain constant, while the distal pivot differential distance changes. In this second scenario, both the anterior and transverse SWA distances may change; however, it may be that the predominant change is to the transverse SWA distance.

FIG. 3D illustrates how the lengths of the first and second arms and other design parameters may be determined in accordance with embodiments of the disclosure. For clarity, FIG. 3D may omit certain labels due to space constraints; these should instead be referenced in conjunction with FIG. 3C. In this figure, the first link 300 has been illustratively disconnected from the second link 302 in order to show geometry associated with the first link and first carriage when the proximal pivot may be in position 112A, while simultaneously showing the geometry associated with the second link and second carriage when the proximal pivot may be in position 112B. Therefore, the geometry shown in FIG. 3D may represent portions of a mechanism, constructed in accordance with the embodiments disclosed, that is in two states, rather than a single state.

The first carriage 132 may be considered to be in the first proximal carriage position as shown in FIG. 3D when the first bearing proximal edge 228 is at its closest position to the first guide proximal edge 224. At this position, the bearing may have a minimum first bearing clearance 340 that may be established to prevent the first bearing from running too close to the proximal edge of the first guide.

Similarly, the second carriage 134 may be considered to be in the second proximal carriage position as shown in FIG. 3D when the second bearing proximal edge 236 is at its closest position to the second guide proximal edge 232. At this position, the bearing may have a minimum second bearing clearance 344 that may be established to prevent the second bearing from running too close to the proximal edge of the second guide.

The first distal pivot 120 may be located a first distal pivot bearing distance 342 from the first bearing proximal edge, and the second distal pivot 122 may be located a second distal pivot bearing distance 346 from the second bearing proximal edge. When the first carriage is in the first proximal carriage position, the first distal pivot may be considered to be in the first distal pivot forward position 120A. Similarly, when the second carriage is in the second proximal carriage position, the second distal pivot may be considered to be in the second distal pivot forward position 122A.

The first link 300 may have a first minimum link length L1′, such that the proximal pivot 112 may be able to reach a point in the sub work-area (SWA) 288 that is furthest from the first distal pivot forward location. This point may be the upper left corner of the SWA (e.g. 112A) as drawn in FIG. 3D. The second link 302 may have a second minimum link length L2′, such that the proximal pivot 112 may be able to reach a point in the sub work-area (SWA) 288 that is furthest from the second distal pivot forward location. This point may be the lower left corner of the SWA (e.g. 112B) as drawn in FIG. 3D.

We may additionally define a second offset distance 348, which may be the distance between the second guide path 126 and the top edge 350 of the SWA.

For the sake of clarity, these parameters have been assigned letter variables thusly:
M—Minimum First Bearing Clearance 340
Q—Minimum Second Bearing Clearance 344
N—First Distal Pivot Bearing Distance 342
R—Second Distal Pivot Bearing Distance 346
L1′—First Minimum Link Length
L2′–Second Minimum Link Length
T—Second Offset Distance 348

The following equations may describe the relationship between the above parameters (including parameters described earlier in this specification) and the designed lengths of the first and second links:

$$T = W - F - S \qquad Eq . 14$$

$$L {1}^{′} = sqrt ( {( D + G + M - N )}^{2} + {( W - F )}^{2} ) \qquad Eq . 15$$

$$L {2}^{′} = sqrt ( {( D + G + R - Q )}^{2} + {( W - T )}^{2} ) \qquad Eq . 16$$

When designing a system in accordance with the embodiments described, the first and second link 300, 302 lengths derived above may be minimum lengths that enable a toolhead that is coaxial with the proximal pivot point 112 to reach all points in a target rectangular sub-working area (SWA) 288 that is located entirely in front of a clearance plane 267.

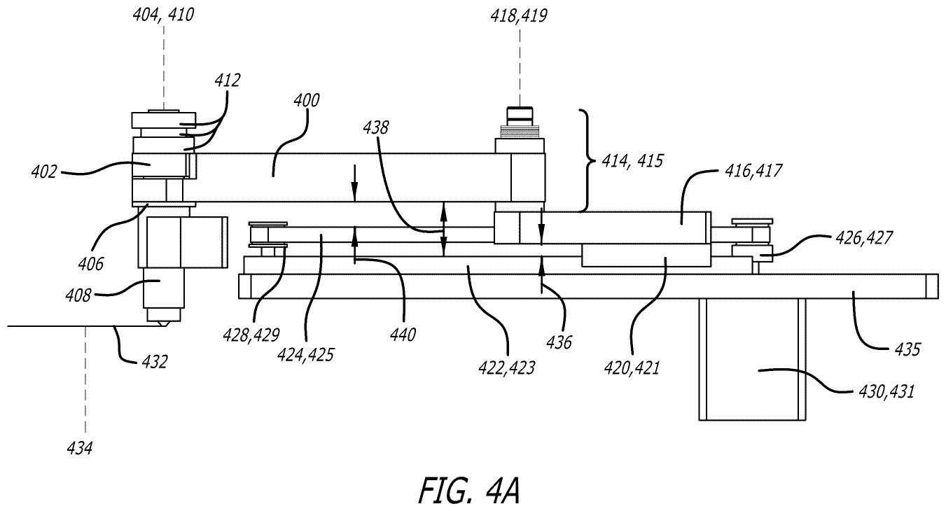

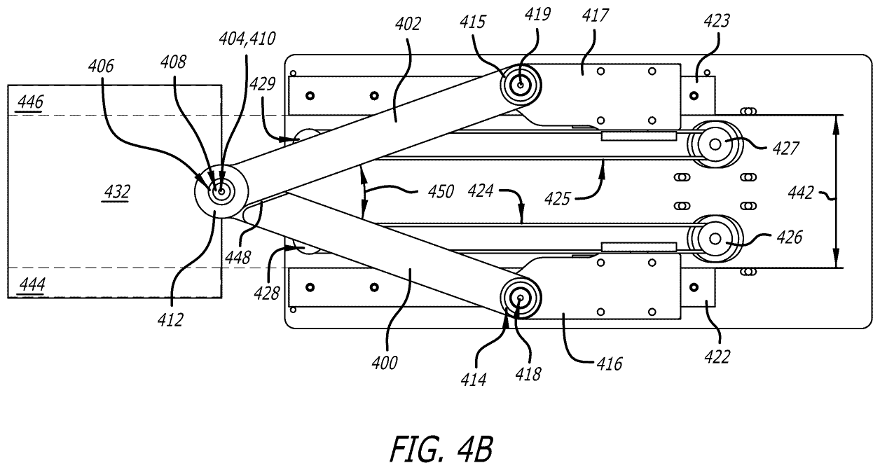

In accordance with the embodiments described, the first and second distal pivot bearing distances may additionally be designed so as to bring the first and second distal pivot forward locations closer to the SWA, which may reduce the minimum lengths of the first and second links. Larger distal pivot bearing distances may allow for shorter arms, which may allow for greater stiffness of the arm itself as well as the distal pivots, and may reduce the rotational inertia of the arms, which may affect dynamic performance of the system. Larger distal pivot bearing distances may also enable greater minimum angles between the arms (see 450 on FIG. 4B, and description later in the specification), which may affect the transfer ratio between carriage motion and toolhead motion, with potential implications for system stiffness and dynamic performance. The distal pivot bearing distances and the arm lengths may also affect the shape of the maximum working area, with potential implications for the size and shape of potential secondary sub-working areas.

FIGS. 3E and 3F illustrate how changing the distal pivot bearing distances and arm lengths, while respecting the relationships imposed by the above equations, may affect the maximum working area shape as well as estimated dynamic performance and other attributes, for a fixed inter guide path distance, primary working area width and depth, minimum bearing clearances, offset distances, and gap distances.

FIG. 3G illustrates a system constructed in accordance with embodiments of the disclosure, in which an SWA midline 550 of a primary sub-working area (SWA) 551 has been shifted by an SWA shift distance 552 from an inter-guide midline 553. We may define the inter-guide midline as a midline between the first and second inner guide edges 276, 278. In some embodiments, the SWA shift distance may be chosen such that the SWA midline 550 lies outside the region of the maximal outer-carriage distance (MOCD) 286. Two systems thus constructed (e.g. with mirrored SWA shift distance directions) may both be able to entirely access a common SWA. In some embodiments of the disclosure, adjacently located systems may be designed such that their sub-working areas overlap in part or in full. Overlap between working areas may be valuable to facilitate multiple operations on the same workpiece (e.g. where system 1 and system 2 may have toolheads with different capabilities), or may allow larger workpieces to be operated on in parallel by multiple systems while enabling the resulting work to be geometrically continuous at the boundaries between machines.

A system constructed in accordance with embodiments of the disclosure, in which the SWA has been shifted by an SWA shift distance, may have first and second arms 554, 555 with link lengths (e.g., the distance between the proximal pivot and the first and second distal pivots, respectively) that may be unequal, as shown in FIG. 3G. The minimum link lengths required for the toolhead to access the entire shifted SWA may still be determined using the equations previously disclosed (e.g. Eq. 15, 16 and the equations on which they are based).

FIG. 3H shows a first system 556 and a second system 557 constructed in accordance with the embodiment of FIG. 3G, that may be placed adjacently with a minimal inter-system running distance 558. We may take inter-machine boundary 559 as a plane separating the first system from the second system at the midline between first system lower edge 560, and second system upper edge 561. A first system may have first and second arms that are curved, bent, or otherwise take on a shape that prevents mechanical interference with the structure or mechanism of adjacent machines (e.g., the second system) during operation of the first system. Such a potential for mechanical interference may be avoided if the arms are shaped such that for example when the toolhead 112 of the first system is in position 112C as shown in FIG. 3H (e.g. the point farthest from the system along the lower edge of the SWA), the first and second arms remain entirely for example to the left of the clearance plane 267 and above the second system lower edge 561. This condition may be conservative, and arm shapes that penetrate these boundaries may still not collide with the adjacent system.

FIG. 3I shows a system constructed in accordance with embodiments of the disclosure, in which toolhead 114 may be coupled to a first arm 100 at its proximal end 102. The first arm may be rotatably coupled to a second arm 106 by a proximal pivot 122, and to a first carriage 116 by a first distal pivot 120. The second arm may additionally be coupled to a second carriage 118 by a second distal pivot 122. In the embodiment of FIG. 3I, the toolhead may not be coaxial with proximal pivot 122, but instead may be offset from the proximal pivot by a distance 570 that is at a toolhead angle 569 relative to the first link 300 connecting the axis of the proximal pivot to the first distal pivot 120. In the embodiment of FIG. 3I, the toolhead may be coupled to the first arm 110. In alternative embodiments, the toolhead may be coupled to the second arm 106. The position of the proximal pivot may be determined using the equations previously disclosed. The position of the toolhead may be determined based on the position of the proximal pivot 112, the toolhead offset distance 570, the toolhead angle 569, and the first link angle 568 (which is the angle between the first guide path 124 and the first link 300). The position of the proximal pivot may be taken within a first reference frame as the anterior 318 and transverse 316 pivot distances of FIG. 3A relative to the reference pivot 308 (e.g. the first distal pivot), or it may be taken within a second reference frame as the anterior 330 and transverse 340 pivot sub-working area distances of FIG. 3C. The toolhead position within either the first (e.g. relative to the reference pivot) or second (e.g. relative to the sub-working area) reference frame may be provided by an anterior toolhead position and a transverse toolhead position, where “anterior” may be taken to mean in direction 571, and “transverse” may be taken to mean in direction 572, as shown.

For clarity, the following parameters have been assigned letter variables thusly:
X′—transverse pivot position (316 or 340)
Y′—anterior pivot position (318, 330)
L4—toolhead offset distance 570
θ3—first link angle 568, as given by Eq. 4.
θ4-toolhead angle 569
U—transverse toolhead axis position
V—anterior toolhead axis position

We may additionally define an intermediate variable θ5 for clarity.

The following equations relate the position of the toolhead within a reference frame, based on: an anterior and transverse position of the proximal pivot within the same reference frame, a toolhead offset distance, and a toolhead angle:

$$θ5 = π - θ3 - θ4 \qquad Eq . 17$$

$$U = {X}^{′} - L 4 * cos ( θ 5 ) \qquad Eq . 18$$

$$V = {Y}^{′} + L 4 * cos ( θ5 ) \qquad Eq . 19$$

Offsetting the toolhead from the proximal pivot may provide greater flexibility in the type and geometry of toolhead that can be accommodated by the system, and may have additional benefits such as enabling access to work areas without mechanically interfering with structure and mechanism belonging to the system or adjacent systems, or affecting the stiffness, resolution, accuracy, dynamic performance, etc of the system.

According to embodiments of the disclosure, the toolhead 114 may be directly coupled to the arm, or may be indirectly coupled with the use of a mount, that in some embodiments may allow multiple toolheads to be interchanged on a single system.

FIG. 4A shows a side view of a system constructed in accordance with embodiments of the disclosure, that is similar to the system of FIG. 1. A first arm 400 is rotatably coupled to a second arm 402 about a proximal pivot axis 404. Coaxial with the proximal pivot axis is a mount 406, to which a toolhead (e.g. a 3D printing extrusion nozzle) 408 is rigidly coupled (e.g. with a threaded interface). This toolhead may have a toolhead axis 410 that may be coaxial with the mount, and which may run through the center of action of the toolhead (e.g. the nozzle orifice of a 3D printing extruder).

In alternative embodiments, the mount may be integral with the toolhead, or the mount axis may not be coaxial with the proximal pivot axis, or the toolhead axis may not be coaxial with the mount axis. In alternative embodiments, the toolhead axis may be perpendicular or at another angle to the proximal pivot axis. A proximal pivot bearing assembly 412, which may be partially located inside the first and second arms, and which may include preload elements, may allow the first and second arm to rotate relative to each other while transmitting load in one or more directions. For example, the proximal pivot bearing assembly may rigidly transfer radial loads (e.g. perpendicular to the toolhead axis) that are externally applied to the toolhead, or that are generated inertially when the toolhead is accelerated or decelerated, into the mount and into the first and second arms. The bearing assembly may additionally transfer axial loads (e.g. loads that are along the toolhead axis) from the toolhead, through the mount, and into the first and second arms. In this way the axial stiffness of the toolhead may benefit from the combined mechanical stiffnesses of the first and second arms.

The proximal pivot bearing assembly may also introduce axial compliance between the arms, which may be advantageous if there are linear (e.g. in the direction of the pivot axis) or angular misalignments between the first and second arms. In alternative embodiments, the first and second arms may be preloaded against each other through the proximal pivot bearing assembly, e.g. to increase stiffness of the positioning system.

A first and second distal bearing assembly (414, 415) rotatably couple the first and second arms to the first and second carriages (416, 417). These bearings assemblies may be partially inside the first and second arms, and may allow the arms to rotate freely about first and second distal pivot axes (418, 419) while rigidly transmitting forces and moments from the arms into the carriages. For example, a force on the toolhead along the toolhead axis may result in a pitch moment at the interface between the first arm and the first carriage, or the interface between the second arm and the second carriage. This pitch moment may be in proportion to both the magnitude of the axial load applied to the toolhead and the distance between the toolhead axis and the distal pivot axis.

The distal bearing assemblies may be constructed so as to rigidly transmit this pitch moment into the carriages. The first and second carriages may be rigidly attached to a first and second bearing (420, 421) respectively, which may be constrained to move along a first and second guide path by a first and second guide (422, 423). These guides may be rigidly coupled to a structure (e.g. a baseplate 435). In such an arrangement, the first and second carriages may move freely along the first and second guide paths, but may be otherwise rigidly coupled to the guides, meaning that forces and moments applied to the carriages that are not in the direction of the guide paths may be transferred into the guides and thereby into the structure. Note that due to the side view of FIG. 4A, first and second elements (e.g. arms, carriages, bearings, guides) may be shown with the second element obstructed. This second element is however implied in the view, and the first and second elements are referred to by (first, second) numerals.

In the embodiment of FIGS. 4A, 4B, a first and second timing belt (424, 425) may be rigidly coupled to the first and second carriage, respectively, and looped around a first and second drive pulley (426, 427) and a first and second idler pulley (428, 429), respectively. The first and second drive pulleys may be rigidly coupled to a first and second stepper motor (430, 431). In accordance with embodiments of this disclosure, rotational motion of the motors may result in translational motion of the carriages about their respective guide paths, which may result in motion of the toolhead in a sub-working area (SWA) 432. We may define a work area axis 434 that is perpendicular to the plane of the SWA. The first and second carriages may be separated from the first and second guides by a carriage-guide distance 436 in the direction of the work area axis. The first and second arms may be separated from the first and second guides by an arm-guide distance 438 in the direction of the work area axis.

The first and second arms may additionally be separated from the first and second belts by an arm-belt distance 440 in the direction of the work area axis; this distance may include any portions of the idler and drive pulleys (e.g. pulley flanges) to the extent that these portions lie underneath the arms in the area swept by the arms while the toolhead accesses the entire work area.

Positive values of the carriage-guide distance, arm-guide distance, arm-belt distance, and other similar distances between moving and fixed elements of the positioning mechanism, may serve as clearance that permits the toolhead axis to access the entire SWA without mechanical interference between elements of the positioning mechanism. This SWA may include portions that lie outside the minimum inter-guide distance (MIGD) 442, such as for example regions 444 and 446 in FIG. 2B.

As an illustrative counter-example: a negative value of the arm-guide distance may require that the arms operate entirely within the MIGD so as not to collide with the guides. This in turn may prevent the positioning system from accessing portions of the SWA that are outside the MIGD. For clarity, a positive value of these distances may be construed to mean that when projections of the corresponding elements onto the plane of the work area may overlap (e.g. in such positions as they may assume during operation), these elements may still be in mechanical clearance with each other because they are separated from each other by a distance along the direction of the work area axis. Conversely, a negative value of these distances may mean that these elements may interfere with each other in some positions, including positions these elements may need to assume in order for the toolhead to otherwise access the entire SWA.

In the embodiment of FIGS. 4A, 4B, the motors are located below the baseplate and oriented with the motor shafts pointing upwards. In alternative embodiments, the motors may be positioned above the baseplate and may have their shafts pointed downwards. For example, this may be accomplished by mounting the motors on standoffs. Such an arrangement may have benefits for keeping the bottom of the baseplate clear so that for example it may rest on or near the surface of a table, or to reduce the envelope of the mechanism, or for other reasons.

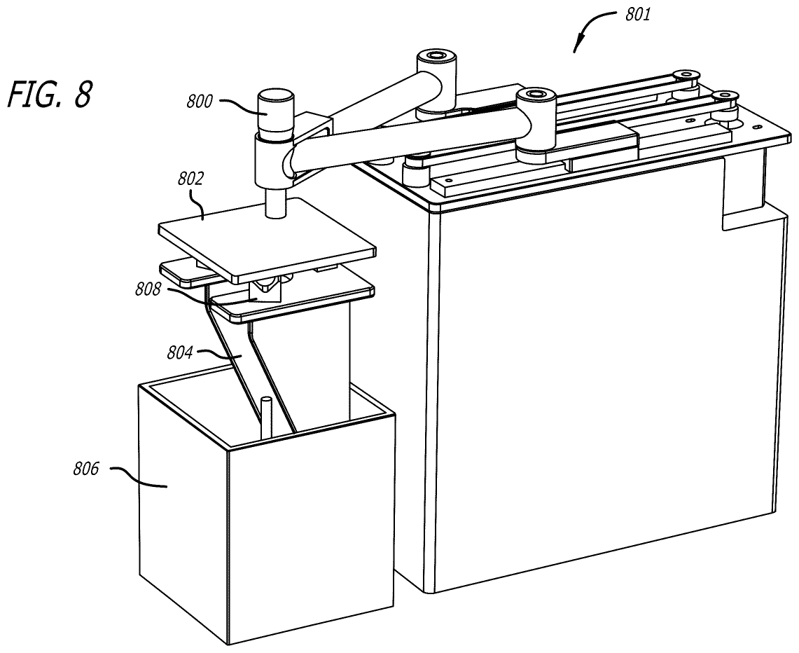

Systems constructed in accordance with the embodiments described may include one or more relieving features 448 in one or more arms, such that the arms can predominantly operate in a coplanar manner (e.g., the arms have some overlap when viewed from the side), but do not interfere where the arms approach the proximal pivot. Co-planar operation of the arms may have mechanical advantages in reducing the overall height of the mechanism, reducing the length of the structural loop, and minimizing moments caused by differential driving forces generated by each arm on the proximal pivot. Such a relieving feature may be designed so as to provide clearance between the arms when the angle between them (e.g. an inter-arm angle 450) is at a minimum. In some embodiments this angle may be taken as the minimum inter-arm angle when the distal pivot differential distance is zero. In alternative embodiments, this relief may be provided in the form of a yoke (e.g. the embodiment disclosed in FIG. 8) or with other approaches.

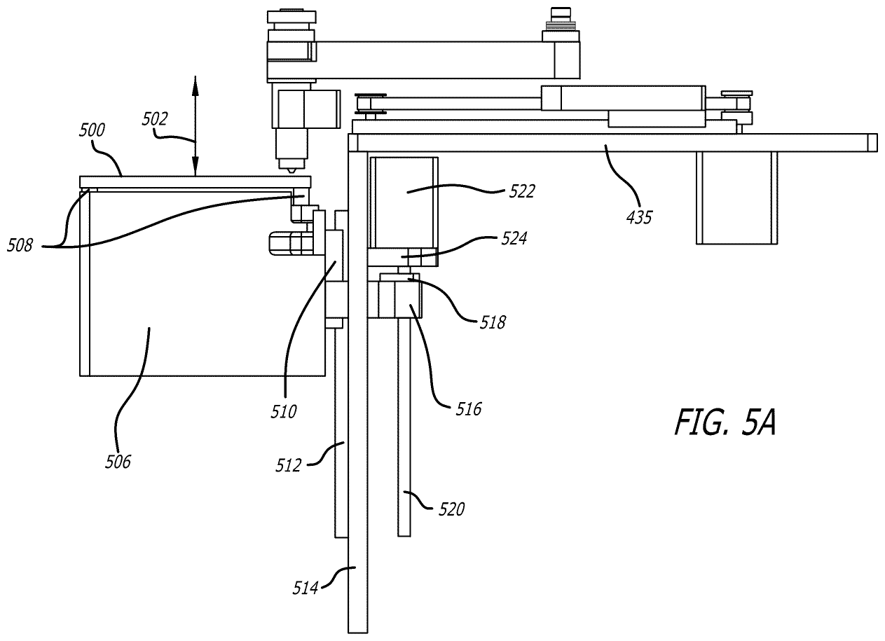

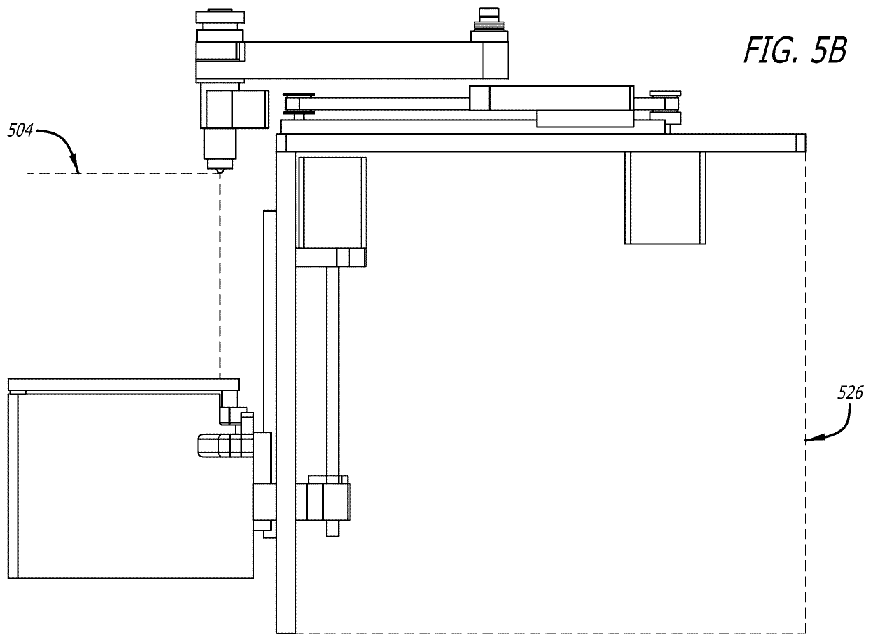

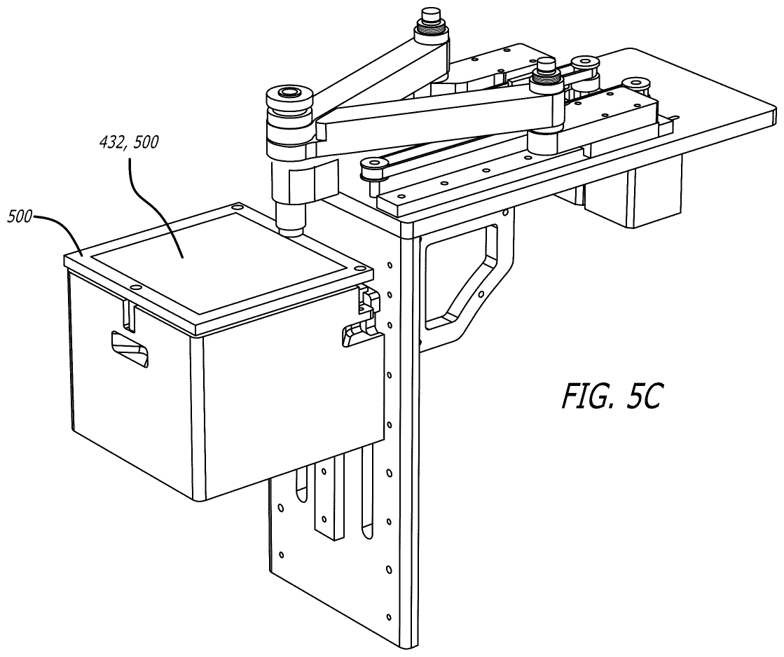

FIGS. 5A-5C illustrate a system constructed in accordance with the embodiments disclosed, in which the planar positioning system of FIG. 4A(which for clarity in this description we will refer to as the XY positioner) is located relative to a working surface 500 (e.g. the build plate for a 3D printer) such that the sub-working area (SWA) may be within the bounds of the working surface. Furthermore, such a working surface may be supported and actuated so that it is able to controllably affect the position of a workpiece on the working surface along a Z direction 502 that may be orthogonal to the plane of the work area 432. A system so constructed may be able to perform work within a working volume (e.g. 504 in FIG. 5B), by moving a toolhead within the working area, and by moving the working surface along the orthogonal Z direction.

The working surface may be mounted to a Z carriage 506, either directly or indirectly (e.g. by using leveling adjusters 508, such that the working surface is parallel to the plane of the work area.) In some embodiments, the position of the Z carriage may be controlled in synchrony with the position of the toolhead in the work area, so as to adjust for situations where the working surface may not be flat or may not be parallel to the plane of the work area. The Z carriage may be coupled to a Z bearing 510, which may travel along a Z guide 512. The Z bearing and Z guide may work together to constrain the motion of the carriage to the Z direction, by rigidly supporting the carriage in all other directions (both rotational and translational). The Z guide may be rigidly mounted to a Z structure (e.g. a Z structural plate 514), which in turn may be directly or indirectly coupled to the baseplate of the XY positioner. A Z nut mount 516 may be coupled to the Z carriage, and a Z nut may be coupled to the Z nut mount, such that forces in the Z direction are rigidly transferred between the carriage and the Z nut. In some embodiments, the z nut mount may be a fully rigid structure, while in other embodiments, the Z nut mount may be designed with selective compliance such that it can accommodate translational or rotational misalignment between the Z nut and the Z carriage without generating deleterious forces, but while accurately transferring motion of the Z nut to the Z carriage under load. A Z leadscrew 520 may pass through the Z nut, and threads on the Z leadscrew may engage with threads in the Z nut, such that when the Z leadscrew rotates, it causes the Z nut to advance in the Z direction. The Z leadscrew may be coupled to a Z motor 522, which may provide a motive force to rotate the Z leadscrew. In some embodiments, the Z leadscrew may be integral to the Z motor. In some embodiments, the Z leadscrew may be coupled to the Z motor using a rigid coupling. In some embodiments, the Z leadscrew may be coupled to the Z motor using a flexible coupling, and the Z leadscrew may be axially and radially supported using standard methods known to those skilled in the art. In some embodiments, the Z leadscrew may be replaced with a ballscrew, or a belt drive, or a rack and pinion, or a capstan drive, or any other transmission system capable of providing suitable accuracy, repeatability, resolution, speed, acceleration, stiffness, etc for a given application for which the system is to be used. Similarly, the Z motor may be a stepper motor, or a DC or AC servo motor, or a linear motor, or any other actuator capable of meeting the performance requirements of the system.

The Z motor may be coupled to the Z structure with a Z motor mount 524. In some embodiments, the Z nut, Z leadscrew, and Z motor may be separated from the carriage by structural elements, through which the Z nut mount may pass (e.g. via slots).

A system constructed in accordance with the disclosed embodiments may have an available region 526 in which components that facilitate the operation of the machine may be placed. This may include e.g. filament spools, electronics, etc..

FIG. 5C shows a 3D isometric view of the system of FIG. 5A.

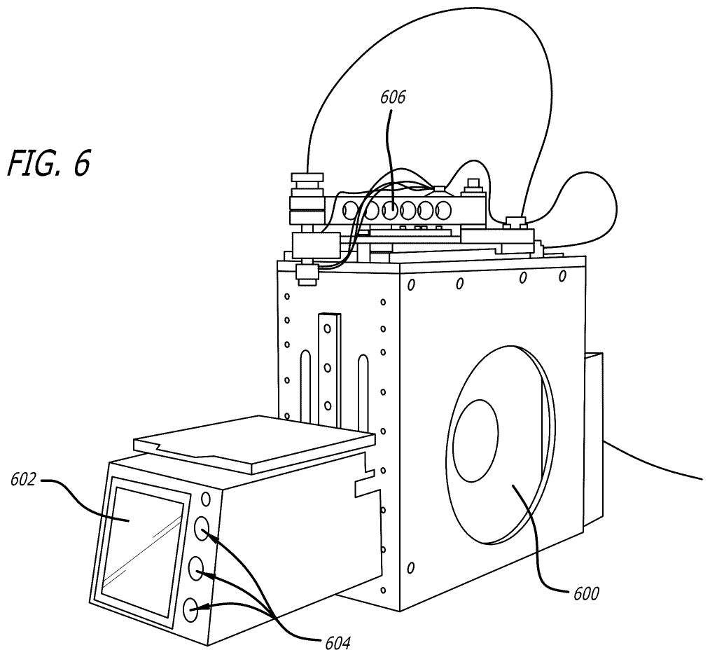

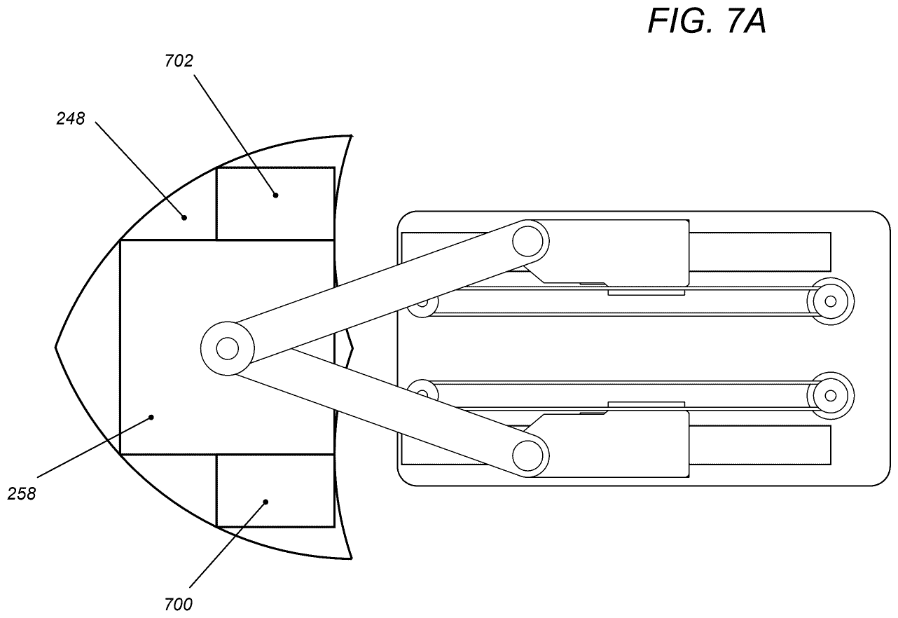

FIG. 6 is an isometric view of a bookshelf 3D printer designed in accordance with the embodiments described. Such a device may have a high spatial efficiency (e.g. >75%, 80%, 85%, 90%, 95%, 100%) in the width-wise direction, allowing it to fit in places that other 3D printers may not fit, or to allow multiple such 3D printers to achieve a high packing density on e.g. a desk or a shelf. In these environments, lateral space may be at a greater premium than depth, and embodiments of the disclosure may be well-suited to taking advantage of this.

In some embodiments, the region enclosed by the planar positioning system and the Z axis (e.g. region 526 in FIG. 5B) may be used to house components that facilitate the operation of the machine, e.g. a filament spool 600 for a 3D printer. The first and second arms may be lightened using a variety of methods, for example material with a tubular cross-section, lightening holes or cutouts 606, or other methods, in order to reduce the moving mass and rotational inertia of each arm about its distal pivot. Such design features may be advantageous for improving the dynamic performance of the system. A user interface screen 602 or physical control elements such as buttons 604 may be affixed to the system to facilitate user interaction.

Embodiments of the disclosure include at least first and second positioning systems for positioning one or more respective tools, wherein, for each of the one or more positioning systems, the system comprises:
a first arm having a first proximal end supporting the tool, and a first distal end;
a second arm having a second proximal end coupled to the first arm by a third pivot, and
   a second distal end;
   a first carriage coupled to the first distal end, wherein the first carriage is movable along a first guide path of a first guide; and
   a second carriage coupled to the second distal end, wherein the second carriage is movable along a second guide path of a second guide, wherein the first and second guides are offset relative to each other,
   wherein:
the first or second carriage, whether moving alone or in combination with the other carriage along the respective first and second guide paths, causes motion of the tool in a plane corresponding to a work area,
the first and second guides are separated by a minimum inter-guide width, wherein the minimum inter-guide width is defined by a minimum distance between lateral inner edges of the first and second guides,
the first and second distal ends are rotatably coupled by first and second pivots to the first and second carriages, respectively,
first and second link lengths are based upon respective distances between the third pivot and the first and second pivots,
a position of the tool is based upon (a) a difference in positions between the first and second pivots, (b) the first and second link lengths, and (c) a position of at least one of the first and second pivots, and
   wherein the first arm of the first positioning system, when supporting a first tool, and the first arm of the second positioning system, when supporting a second tool, enable work by the first and second tools within a common work area comprising an overlap of the work areas of the first and second tools.

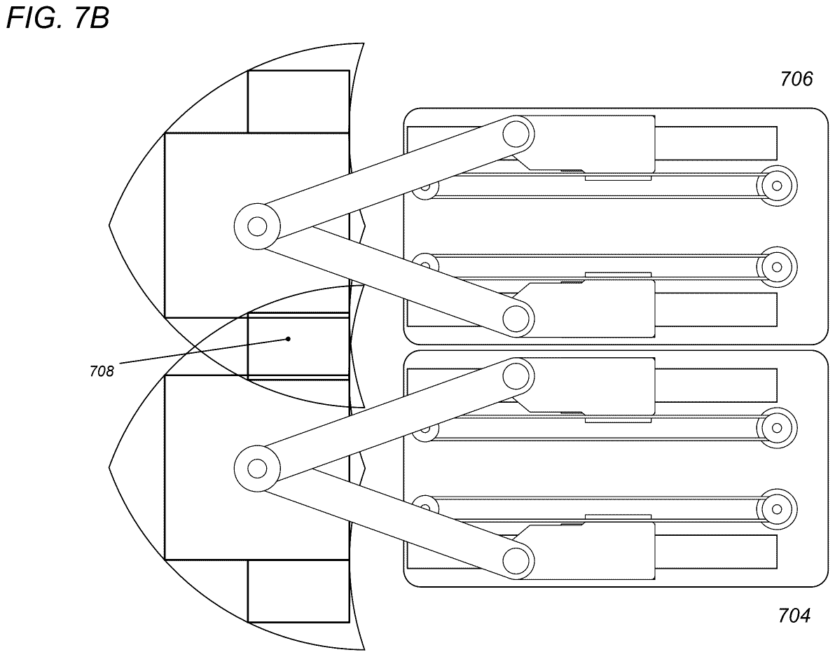

FIG. 7A shows another embodiment of the disclosure, in which a primary sub-work area 258 is defined within a maximal working area (MWA) 248, and at least one other secondary sub-working area (SSWA) may also be defined within the MWA (e.g. a first SSWA 700 and a second SWWA 702).

FIG. 7B illustrates an arrangement consisting of two adjacently located systems constructed in accordance with the embodiments disclosed, in which there is a partial or full overlap of secondary sub-working areas between the machines, meaning that a first system 704 may be able to access part or all of an SSA of the second system 706, or the second system may be able to access part or all of an SSA of the first system.

For example, there may be a common region 708 that is reachable by both systems that may partially overlap or may not partially overlap with each systems' primary work areas. Such an affordance may be useful for passing material or workpieces between adjacent systems. Other relative orientations of multiple systems may access shared secondary sub-working areas. For example, systems may be oriented 90 degrees apart, or 180 degrees apart, etc.

FIG. 8 shows another embodiment of the disclosure, in which a toolhead 800 is positioned relative to a working surface 802 by a planar positioning system 801 constructed in accordance with embodiments of the disclosure. The working surface may be attached to a lift axis consisting of a moveable lift platform 804 and a stationary frame 806. The working surface may be coupled to the lift platform with a kinematic coupling 808. In this embodiment, the lift platform may be considered a module that may be placed relative to the planar positioning system.

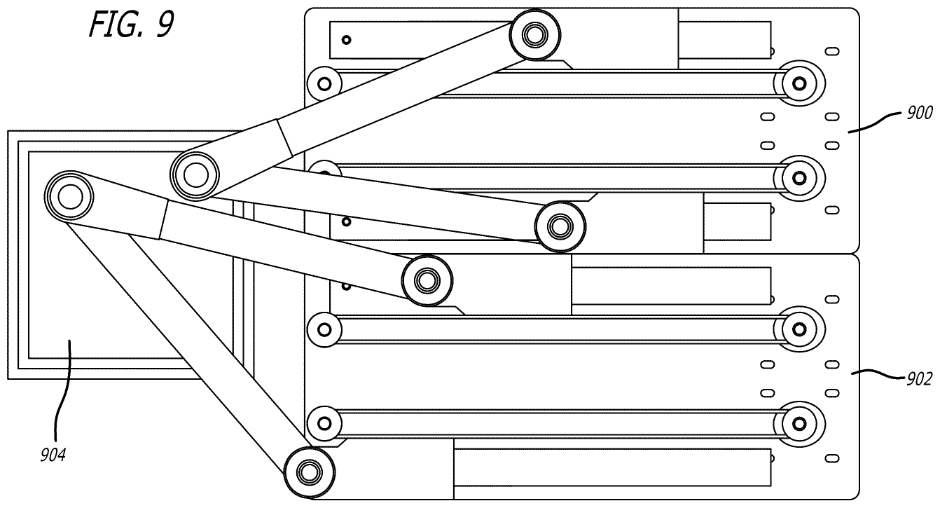

FIG. 9 shows how two positioning systems 900 and 902, constructed in accordance with embodiments of the disclosure, may be adjacently positioned and perform work on a common working area 904. These systems may simultaneously move within the common working area and may be coordinated to avoid collisions, or they may also take turns entering and exiting the common working area.

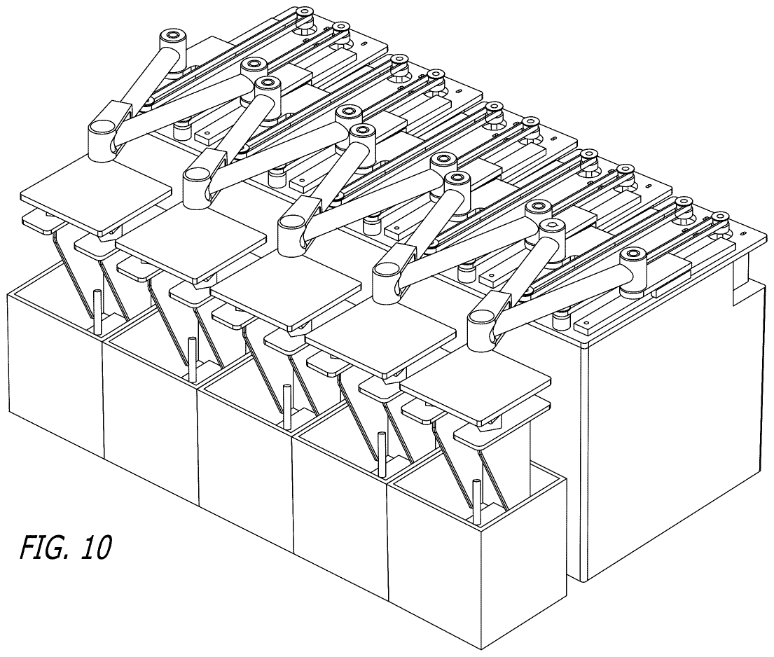

FIG. 10 shows how multiple positioning systems may be arrayed adjacently to achieve high lateral packing densities. These positioning systems may each have their own work surfaces, or may share work surfaces that span the working areas of multiple machines. These positioning systems may have distinct working areas or sub-working areas, or may have overlap between their working areas. When overlap exists between the working areas, these positioning systems may perform work on a common workpiece. Individual systems or subsets of systems may operate independently or in synchrony.

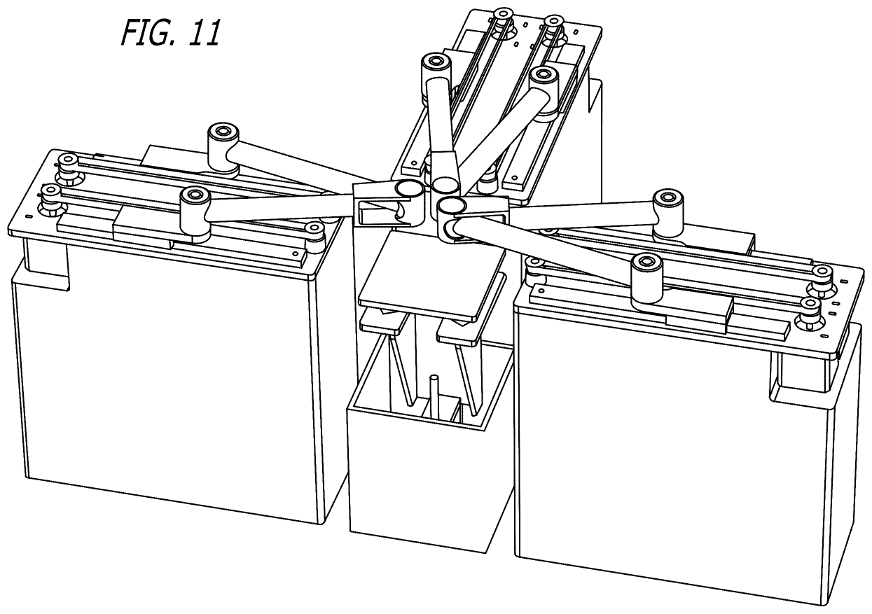

FIG. 11 shows multiple positioning systems (e.g., three systems) arranged in order to access a common working area (e.g., with each system oriented orthogonally to its neighbor). This is made possible in part because embodiments of the present disclosure may enable open access to their working areas from three sides. Many other arrangements are possible that take advantage of affordances of the embodiments disclosed, including relative angles between systems that are not 90 degrees, or that are not rotations within a single plane.

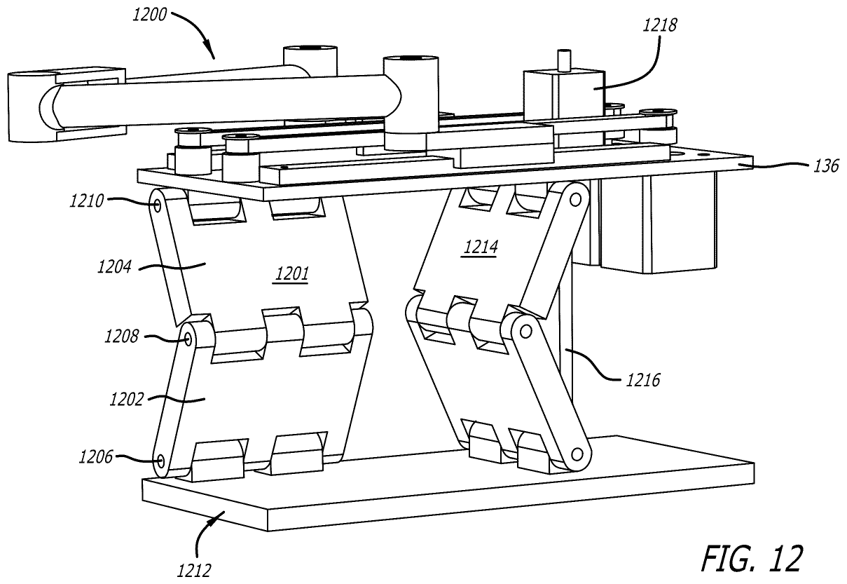

FIG. 12 shows an embodiment of the disclosure, in which a 2D planar positioning system 1200 constructed in accordance with embodiments of the disclosure may be actuated to move in a third direction that may be perpendicular to its work area. A first stabilizing linkage 1201 may consist of: a first stabilizing link 1202 that at one end may be rotatably coupled to a sub-base 1212; a second stabilizing link 1204 that at one end is rotatably coupled to the first stabilizing link by a pivot 1208, and at the other end is rotatably coupled to a baseplate 136 of the 2D planar positioning system 1200 with a pivot 1210. A second stabilizing linkage of similar construction may couple to both the sub-base 1212 and the baseplate 136, and may be oriented orthogonally to the first stabilizing link as shown.

In such a configuration, the stabilizing linkages may allow free displacement of the baseplate relative to the sub-base in a direction of travel, but may otherwise rigidly transfer loads (e.g. forces and moments) between the positioning system and the sub-base with acceptable deflection. The dimensions and locations of the stabilizing linkages may be chosen to achieve a target structural stiffness between the sub-base and the baseplate, or to provide a desired range of travel of the positioning system relative to the sub-base, or to avoid mechanical interference between components of the first and second stabilizing linkages, or between each of these stabilizing linkages and adjacent components.

A motor 1218 may be mounted to the baseplate 136, and by rotating may cause a leadscrew 1216 that may pass thru the motor to translate in accordance with the rotation of the motor, due to a threaded interface between the rotor of the motor and the leadscrew. The leadscrew may be rigidly coupled along its axial direction to the sub-base, such that when the leadscrew translates it causes the baseplate to similarly translate in the direction of free travel of the stabilizing linkages.

Systems constructed in accordance with some embodiments of the disclosure may utilize an actuated working surface (e.g., 500 in FIG. 5A) to access a working volume, as previously described. In the embodiment of FIG. 12, the planar positioning system may itself be actuated such that the tool may access a work volume, which may have advantages in certain situations.

For example, multiple systems thus constructed may be arranged relative to each other such that they can perform work on a common workpiece or common work surface, and yet access all positions within their working volume independently. This may be useful for situations where some toolheads may disengage from the workpiece, or may need to independently actuate orthogonally to the work surface in order to e.g. drill holes, install threaded inserts, pipette liquids, place components, etc. For clarity, this contrasts with the embodiment of FIG. 8, in which systems 800 and 802 may independently position their toolheads within their respective work areas, but the position of each toolhead in a direction orthogonal to the work area may be coupled so as to at all times change equally by the actuation of the shared work surface.

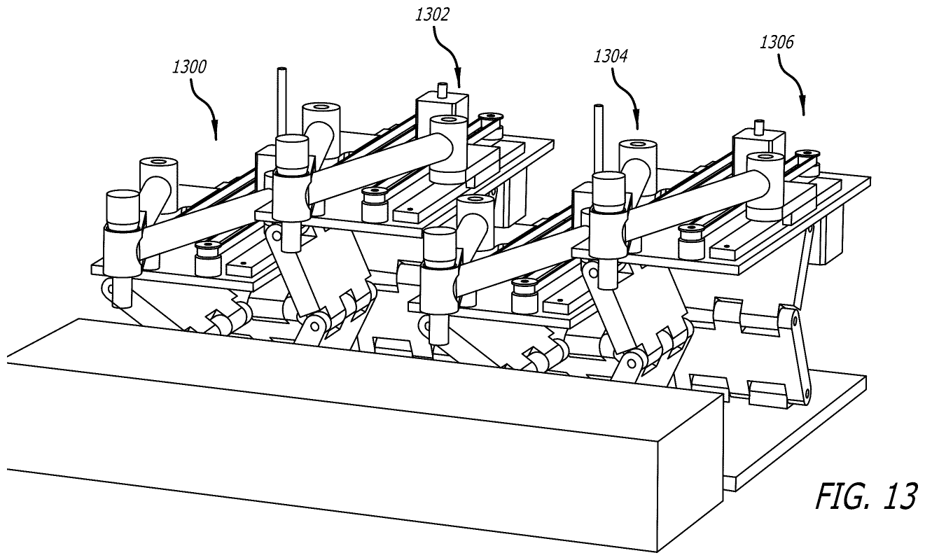

FIG. 13 illustrates an arrangement of systems constructed in accordance with the embodiments of the disclosure, in which multiple positioning systems (e.g. 1300, 1302, 1304, 1306) are able to each independently position a their respective toolheads within a working volume. Each of these systems consists of a 2D planar positioning system constructed in accordance with embodiments of the disclosure, which may be actuated in a third orthogonal direction independently in the manner of FIG. 12.

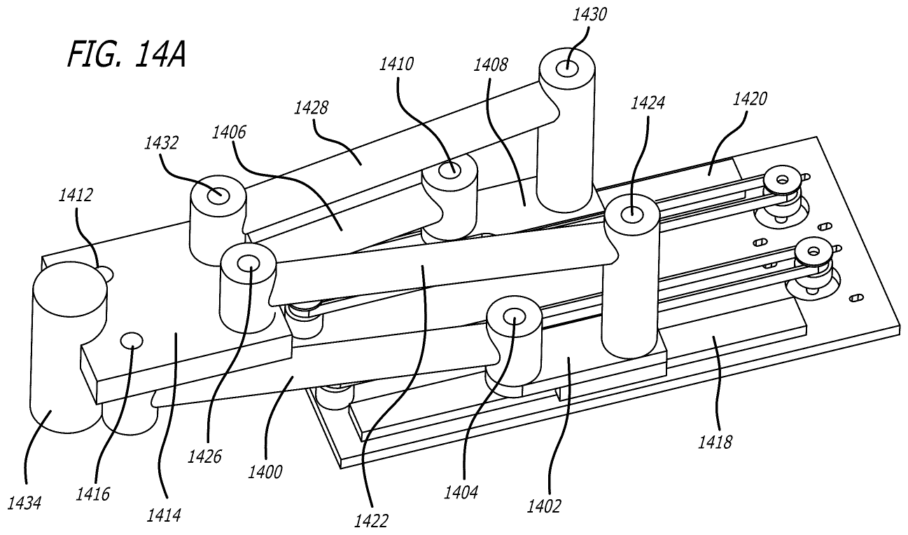

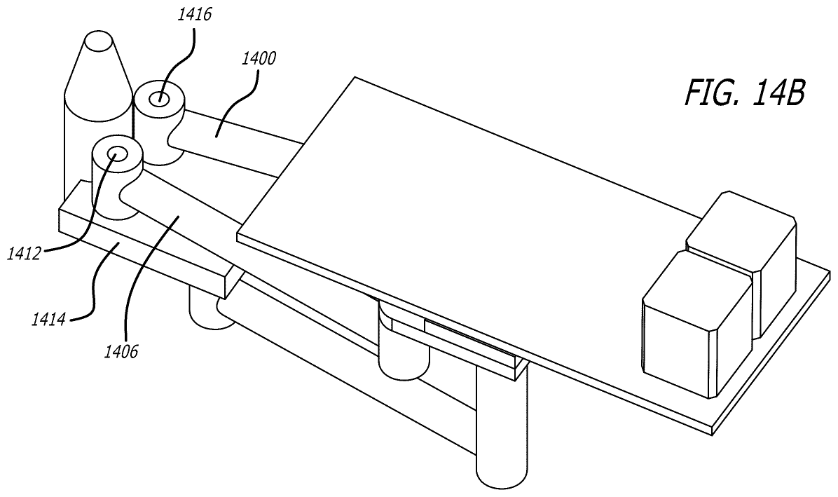

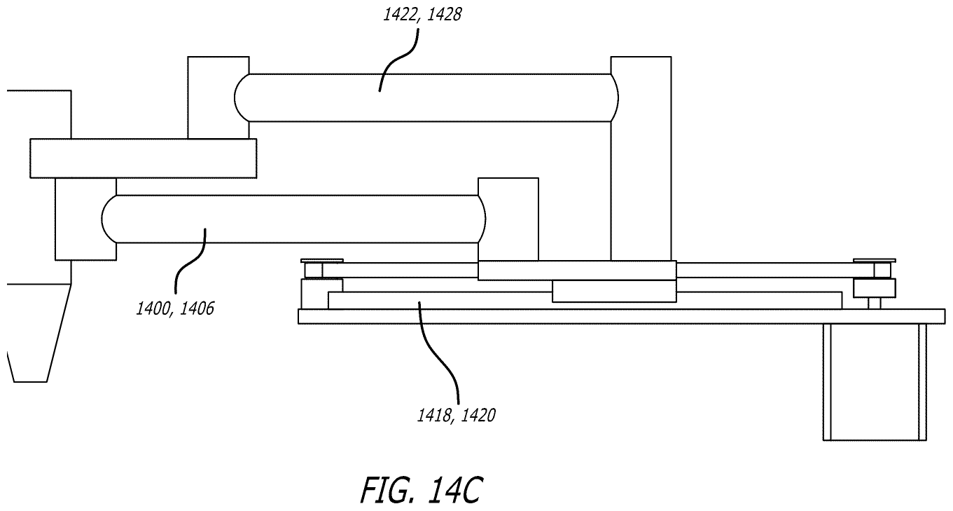

FIGS. 14A-14C shows an embodiment of the disclosure, in which a first arm 1400 has a first distal end coupled to a first carriage 1402 by a first pivot 1404, and a second arm 1406 has a second distal end coupled to a second carriage 1408 by a second pivot 1410. The second arm 1406 has a second proximal end indirectly coupled to the first arm by a third pivot 1412, a support plate 1414, and a fourth pivot 1416. The first and second carriages are constrained to move along a first and second guide path by a first guide 1418 and a second guide 1420 respectively.

A third arm 1422 has a third distal end coupled to the first carriage by a fifth pivot 1424, and a third proximal end coupled to the support plate 1414 by a sixth pivot 1426. In this way the first and third arm may operate in conjunction with the first carriage and the support plate to act as a four-bar linkage that maintains parallelism of the support plate relative the first carriage, in most positions of the support plate relative to the first carriage. A fourth arm 1428 has a fourth distal end coupled to the second carriage 1408 by a seventh pivot 1430, and a fourth proximal end coupled to the support plate by an eighth pivot 1432. In this way the second and fourth arm may operate in conjunction with the second carriage and the support plate to act as a four-bar linkage that maintains parallelism of the support plate relative to the second carriage, in positions where the four-bar linkage of the first and third arms may approach a singularity point.

A toolhead 1434 may be coupled to the support plate, such that when the first and second carriages may be moved along the first and second guides respectively, the toolhead may be positioned within a working area while maintaining its rotational orientation about the axis of the toolhead. This fixed orientation may be valuable for certain types of toolheads, for example an imaging sensor where it may be desirable for the orientation of the frame to be held constant.

FIG. 14B shows the system of 14A from the bottom, so that the third pivot 1412 and the fourth pivot 1416 may be better seen.

FIG. 14C shows the system of 14A from the side, illustrating how the first and third arms may be located on a different plane than the second and fourth arms, such that the tool is able to move freely throughout a working area that may exceed the minimum inter-guide distance (e.g. 280 on FIG. 2C) without mechanical interferences between the arms and the guides, or between any of the arms, or between the arms and other components of the mechanism or structure.

Those skilled in the art will understand that some or all of the elements of embodiments of the disclosure, and their accompanying operations, may be implemented wholly or partially in hardware, software or firmware, as would be recognized by a skilled artisan. Embodiments of the disclosure may be implemented by one or more computer systems including one or more processors and one or more memory systems. Some elements and functionality may be implemented locally and others may be implemented in a distributed fashion over a network through different servers, e.g., in client-server fashion, for example.

Although the disclosure may not expressly disclose that some embodiments or features described herein may be combined with other embodiments or features described herein, this disclosure should be read to describe any such combinations that would be practicable by one of ordinary skill in the art.

Unless otherwise indicated herein, the term “include” shall mean “include, without limitation,” and the term “or” shall mean non-exclusive “or” in the manner of “and/or.” Unless otherwise indicated herein, the phrase “based upon” or the like means “based at least in part upon” or the like, and shall not be limited to mean “based solely on” or the like.

All references cited herein, including, without limitation, articles, publications, patents, patent publications, and patent applications, are incorporated by reference in their entireties for all purposes, except that any portion of any such reference is not incorporated by reference herein to the extent it: (1) is inconsistent with embodiments of the disclosure expressly described herein; (2) limits the scope of any embodiments described herein; or (3) limits the scope of any terms of any claims recited herein. Mention of any reference, article, publication, patent, patent publication, or patent application cited herein is not, and should not be taken as an acknowledgment or any form of suggestion that it constitutes valid prior art or forms part of the common general knowledge in any country in the world, or that it discloses essential matter.

In the claims below, a claim n reciting “any one of the preceding claims starting with claim x,” shall refer to any one of the claims starting with claim x and ending with the immediately preceding claim (claim n−1). For example, claim 35 reciting “The system of any one of the preceding claims starting with claim 28” refers to the system of any one of claims 28-34.

### EMBODIMENTS SECTION

Note: An embodiment (referred to informally as “claim” in this Embodiments section) within a set (below) that depends upon another claim refers to a dependent claim within the same claim set.

### Embodiment Claim Set 1: One or More Systems

1. One or more positioning systems for positioning one or more respective tools, wherein, for each of the one or more positioning systems,
   the system comprises:
      a first arm having a first proximal end supporting the tool, and a first distal end;
      a second arm having a second proximal end coupled to the first arm by a third pivot, and
   a second distal end;
   a first carriage coupled to the first distal end, wherein the first carriage is movable along a first guide path of a first guide; and
   a second carriage coupled to the second distal end, wherein the second carriage is movable along a second guide path of a second guide, wherein the first and second guides are offset relative to each other,
   wherein:
      the first or second carriage, whether moving alone or in combination with the other carriage along the respective first and second guide paths, causes motion of the tool in a plane corresponding to a work area,
      the first and second guides are separated by a minimum inter-guide width, wherein the minimum inter-guide width is defined by a minimum distance between lateral inner edges of the first and second guides,
      the first and second distal ends are rotatably coupled by first and second pivots to the first and second carriages, respectively,
      first and second link lengths are based upon respective distances between the third pivot and the first and second pivots,
      a position of the tool is based upon (a) a difference in positions between the first and second pivots, (b) the first and second link lengths, and (c) a position of at least one of the first and second pivots, and
      the motion of the first and second distal ends is operable to induce travel of the tool beyond first and second boundaries defined by the minimum inter-guide width, so that the work area laterally extends beyond the minimum inter-guide width.
2. The system of claim 1, wherein the first and second arms are offset from the first and second guides to avoid collision of the first and second arms with the first and second guides.
3. The system of any one of the preceding claims, wherein
   the first and second distal ends of the first and second arms can travel along the first and second guide paths, respectively, at their furthest extent to respective first and second proximal points, and to respective first and second distal points, and
   the work area is defined by the area traversed by motion of the tool due to (a) motion of the first distal end over all points between the first proximal point and the first distal point, and (b) motion of the second distal end over all points between the second proximal point and the second distal point.
4. The system of any one of the preceding claims, wherein the work area comprises a primary work area and one or more secondary work areas, wherein the area of the primary work area is greater than the area of any one of the secondary work areas.
5. The system of claim 4, wherein the primary and secondary work areas include rectangular areas.
6. The system of any one of the preceding claims, further comprising first and second actuators for respectively driving the first and second carriages along the first and second guides in the same direction at the same time or in opposite directions.
7. The system of any one of the preceding claims, wherein the first and second arms have different lengths.
8. The system of any one of the preceding claims, wherein each of the first and second arms does not comprise a movable joint between its proximal and distal ends (not inclusive of the ends themselves).
9. The system of any one of the preceding claims, wherein the first and second guide paths are linear guide paths.
10. The system of any one of the preceding claims, wherein the first and second arms are curved to avoid collision of the first and second arms with the first and second guides.

### Embodiment Claim Set 2: Multiple Systems

1. First and second positioning systems for positioning one or more respective tools, wherein, for each of the one or more positioning systems,
   the system comprises:
      a first arm having a first proximal end supporting the tool, and a first distal end;
      a second arm having a second proximal end coupled to the first arm by a third pivot, and
   a second distal end;
   a first carriage coupled to the first distal end, wherein the first carriage is movable along a first guide path of a first guide; and
   a second carriage coupled to the second distal end, wherein the second carriage is movable along a second guide path of a second guide, wherein the first and second guides are offset relative to each other,
   wherein:
      the first or second carriage, whether moving alone or in combination with the other carriage along the respective first and second guide paths, causes motion of the tool in a plane corresponding to a work area,
      the first and second guides are separated by a minimum inter-guide width, wherein the minimum inter-guide width is defined by a minimum distance between lateral inner edges of the first and second guides,
      the first and second distal ends are rotatably coupled by first and second pivots to the first and second carriages, respectively,
      first and second link lengths are based upon respective distances between the third pivot and the first and second pivots,
      a position of the tool is based upon (a) a difference in positions between the first and second pivots, (b) the first and second link lengths, and (c) a position of at least one of the first and second pivots, and
   wherein the first arm of the first positioning system, when supporting a first tool, and the first arm of the second positioning system, when supporting a second tool, enable work by the first and second tools within a common work area comprising an overlap of the work areas of the first and second tools.
2. The first and second positioning systems of claim 1, wherein the first and second positioning systems enable work by the first and second tools on the same workpiece.
3. The first and second positioning systems of claim 1, wherein the first and second positioning systems enable work by the first and second tools on the same workpiece.

What is claimed is:

1. One or more positioning systems for positioning one or more respective tools, wherein, for each of the one or more positioning systems,
the system comprises:
a first arm having a first proximal end supporting the tool, and a first distal end;
a second arm having a second proximal end coupled to the first arm by a third pivot, and
a second distal end;
a first carriage coupled to the first distal end, wherein the first carriage is movable along a first guide path of a first guide; and
a second carriage coupled to the second distal end, wherein the second carriage is movable along a second guide path of a second guide, wherein the first and second guides are offset relative to each other,
wherein:
the first or second carriage, whether moving alone or in combination with the other carriage along the respective first and second guide paths, causes motion of the tool in a plane corresponding to a work area,
the first and second guides are separated by a minimum inter-guide width, wherein the minimum inter-guide width is defined by a minimum distance between lateral inner edges of the first and second guides,
the first and second distal ends are rotatably coupled by first and second pivots to the first and second carriages, respectively,
first and second link lengths are based upon respective distances between the third pivot and the first and second pivots,
a position of the tool is based upon (a) a difference in positions between the first and second pivots, (b) the first and second link lengths, and (c) a position of at least one of the first and second pivots, and
the motion of the first and second distal ends is operable to induce travel of the tool beyond first and second boundaries defined by the minimum inter-guide width, so that the work area laterally extends beyond the minimum inter-guide width.

2. The system of claim 1, wherein the first and second arms are offset from the first and second guides to avoid collision of the first and second arms with the first and second guides.

3. The system of claim 1, wherein
the first and second distal ends of the first and second arms can travel along the first and second guide paths, respectively, at their furthest extent to respective first and second proximal points, and to respective first and second distal points, and
the work area is defined by the area traversed by motion of the tool due to (a) motion of the first distal end over all points between the first proximal point and the first distal point, and (b) motion of the second distal end over all points between the second proximal point and the second distal point.

4. The system of claim 1, wherein the work area comprises a primary work area and one or more secondary work areas, wherein the area of the primary work area is greater than the area of any one of the secondary work areas.

5. The system of claim 4, wherein the primary and secondary work areas include rectangular areas.

6. The system of claim 1, further comprising first and second actuators for respectively driving the first and second carriages along the first and second guides in the same direction at the same time or in opposite directions.

7. The system of claim 1, wherein the first and second arms have different lengths.

8. The system of claim 1, wherein each of the first and second arms does not comprise a movable joint between its proximal and distal ends (not inclusive of the ends themselves).

9. The system of claim 1, wherein the first and second guide paths are linear guide paths.

10. The system of claim 1, wherein the first and second arms are curved to avoid collision of the first and second arms with the first and second guides.

11. First and second positioning systems for positioning one or more respective tools, wherein, for each of the one or more positioning systems,
the system comprises:
a first arm having a first proximal end supporting the tool, and a first distal end;
a second arm having a second proximal end coupled to the first arm by a third pivot, and a second distal end;
a first carriage coupled to the first distal end, wherein the first carriage is movable along a first guide path of a first guide; and
a second carriage coupled to the second distal end, wherein the second carriage is movable along a second guide path of a second guide, wherein the first and second guides are offset relative to each other,
wherein:
the first or second carriage, whether moving alone or in combination with the other carriage along the respective first and second guide paths, causes motion of the tool in a plane corresponding to a work area,
the first and second guides are separated by a minimum inter-guide width, wherein the minimum inter-guide width is defined by a minimum distance between lateral inner edges of the first and second guides,
the first and second distal ends are rotatably coupled by first and second pivots to the first and second carriages, respectively,
first and second link lengths are based upon respective distances between the third pivot and the first and second pivots,
a position of the tool is based upon (a) a difference in positions between the first and second pivots, (b) the first and second link lengths, and (c) a position of at least one of the first and second pivots, and
wherein the first arm of the first positioning system, when supporting a first tool, and the first arm of the second positioning system, when supporting a second tool, enable work by the first and second tools within a common work area comprising an overlap of the work areas of the first and second tools.

12. The first and second positioning systems of claim 11, wherein the first and second positioning systems enable work by the first and second tools on the same workpiece.
